(19) United States
(12) Patent Application Publication
(10) Pub. No.: US 2023/0172119 A1
(43) Pub. Date: Jun. 8, 2023

(54) METHODS, SYSTEMS, APPARATUSES AND DEVICES FOR FACILITATING CULTIVATION OF PLANTS

(71) Applicant: Karpos Cultivation, IRVINE, CA (US)

(72) Inventor: Sai Kong Frank Lee, IRVINE, CA (US)

(21) Appl. No.: 18/060,303

(22) Filed: Nov. 30, 2022

Related U.S. Application Data
(60) Provisional application No. 63/285,417, filed on Dec. 2, 2021.

(51) Int. Cl. A01G 9/02; A01G 9/24; A01G 27/00; A01G 18/00; A01G 22/15

(52) U.S. Cl. CPC A01G 9/028; A01G 9/249; A01G 27/003; A01G 27/008; A01G 27/005; A01G 18/00; A01G 22/15

(57) ABSTRACT

An apparatus for facilitating cultivation of plants. The apparatus comprises a top enclosure, a bottom enclosure, a vertical column, a cover, a tray, sensors, environmental actuators, a nutrition container, and a processing device. Further, the top enclosure houses a first component. Further, the bottom enclosure houses a second component. Further, the vertical column is interspersed between the top enclosure and the bottom enclosure is forming an interior space therebetween. Further, the cover is interspersed between the top enclosure and the bottom enclosure, encloses the interior space and allows light to enter from a surrounding of the apparatus into the interior space. Further, the tray holds a plant. Further, the sensors generate sensor data representing variables. Further, the environmental actuators control environmental variables. Further, the nutrition container contains a nutritional medium. Further, the processing device controls the environmental actuators based on the sensor data.

### TECHNICAL FIELD

Generally, the present disclosure relates to the field of agriculture. More specifically, the present disclosure relates to methods, systems, apparatuses and for facilitating cultivation of plants.

### BACKGROUND

Nowadays, growing plants and herbs can be a complex task and involves a huge financial investment for factors such as the cost of seeds, fertilizers, labor, nutrition fluids, power supply, etc. Further, growing plants and herbs involve timely application and adjustment of growth factors such as light, temperature, humidity, nutrition, etc. Further, controlling these growth factors based on the growth stage of the plants can be a difficult task.

Existing techniques for facilitating cultivation of plants are deficient with regard to several aspects. For instance, current technologies are specifically designed to allow growing plants without any control. As a result, different technologies are needed to dynamically automate the controlling of the growth of the plants in real-time. Furthermore, current technologies are specifically designed to set plantation conditions for the plants. As a result, different technologies are needed to dynamically control the plantation conditions (such as mist, light, and temperature) for the plants based on an artificial intelligence model and consequently perform a planting action (such as irrigating plants, provisioning nutrition fluid, application of fertilizers, controlling temperature, etc.). Moreover, current technologies are specifically designed to perform plating actions for plants. As a result, different technologies are needed to detect the growth of plants using sensors and then perform the planting actions to help reach the plants at their fullest potential to provide maximum yield.

Therefore, there is a need for improved methods, systems, apparatuses, and devices for facilitating cultivation of plants that may overcome one or more of the above-mentioned problems and/or limitations.

### BRIEF SUMMARY

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

Disclosed herein is an apparatus facilitating cultivation of plants in accordance with some embodiments. Accordingly, the apparatus may include a top enclosure, a bottom enclosure, a vertical column, a cover, a tray, a plurality of sensors, a plurality of environmental actuators, a nutrition container, and a processing device. Further, the top enclosure may be configured for housing at least one first component. Further, the bottom enclosure may be configured for housing at least one second component. Further, the vertical column may be interspersed between the top enclosure and the bottom enclosure may be forming an interior space therebetween. Further, the cover may be interspersed between the top enclosure and the bottom enclosure. Further, the cover may be configured for enclosing the interior space. Further, the cover may be configured for allowing light to enter from a surrounding of the apparatus into the interior space. Further, the tray may be configured for holding a plant. Further, the plurality of sensors may be configured for generating a plurality of sensor data representing a plurality of variables associated with the interior space. Further, the plurality of environmental actuators may be configured for controlling a plurality of environmental variables associated with the interior space. Further, the nutrition container may be configured for containing a nutritional medium. Further, the processing device may be communicatively coupled to the plurality of sensors and the plurality of environmental actuators. Further, the processing device may be configured for controlling the plurality of environmental actuators based on the plurality of sensor data.

Further disclosed herein is an apparatus for facilitating cultivation of plants, in accordance with some embodiments. Accordingly, the apparatus may include a top enclosure, a bottom enclosure, a vertical column, a cover, a tray, a plurality of sensors, a plurality of environmental actuators, a nutrition container, and a processing device. Further, the top enclosure may be configured for housing at least one first component. Further, the bottom enclosure may be configured for housing at least one second component. Further, the vertical column may be interspersed between the top enclosure and the bottom enclosure may be forming an interior space therebetween. Further, the vertical column may include a plurality of fasteners disposed on either end of the vertical column. Further, the plurality of fasteners may be configured for detachably coupling the vertical column to each of the top enclosure and the bottom enclosure. Further, the cover may be interspersed between the top enclosure and the bottom enclosure. Further, the cover may be configured for enclosing the interior space. Further, the cover may be configured for allowing light to enter from a surrounding of the apparatus into the interior space. Further, the tray may be configured for holding a plant. Further, the plurality of sensors may be configured for generating a plurality of sensor data representing a plurality of variables associated with the interior space. Further, the plurality of environmental actuators may be configured for controlling a plurality of environmental variables associated with the interior space. Further, the nutrition container may be configured for containing a nutritional medium. Further, the processing device may be communicatively coupled to the plurality of sensors and the plurality of environmental actuators. Further, the processing device may be configured for controlling the plurality of environmental actuators based on the plurality of sensor data.

Further disclosed herein is an apparatus for facilitating cultivation of plants, in accordance with some embodiments. Accordingly, the apparatus may include a top enclosure, a bottom enclosure, a vertical column, a cover, a nutrition container, a tray, a plurality of sensors, a plurality of environmental actuators, and a processing device. Further, the top enclosure may be configured for housing at least one first component. Further, the top enclosure may include a top outer surface and a top inner surface. Further, the top outer surface may be opposed to the top inner surface. Further, the bottom enclosure may be configured for housing at least one second component. Further, the bottom enclosure may include a venting hole leading into a bottom interior space. Further, the venting hole may provide fluid communication between the bottom interior space and an external space surrounding the apparatus. Further, the bottom enclosure may include a bottom inner surface and a bottom outer surface such that the bottom inner surface opposes the top inner surface. Further, the vertical column may be interspersed between the top enclosure and the bottom enclosure forming an interior space therebetween. Further, the vertical column may include a plurality of fasteners disposed on either end of the vertical column. Further, the plurality of fasteners may be configured for detachably coupling the vertical column to each of the top enclosure and the bottom enclosure. Further, the cover may be interspersed between the top enclosure and the bottom enclosure. Further, the cover may be configured for enclosing the interior space. Further, the cover may be configured for allowing light to enter from a surrounding of the apparatus into the interior space. Further, the cover may be removably attached to a bottom periphery of the bottom inner surface using a friction clasp. Further, the nutrition container may be configured for containing a nutritional medium. Further, the tray may be configured for holding a plant. Further, the tray may include a water inlet. Further, the water inlet may be configured for receiving water and nutrition into the nutrition container. Further, the tray may include a tray top surface and a tray bottom surface. Further, the tray bottom surface may include fins. Further, the fins may be configured for guiding a flow of mist. Further, the tray may include a tray for plant, a tray for micro green, and a tray for mushroom. Further, the tray for plant may include at least one plant holder. Further, the at least one plant holder may be configured for holding a plant. Further, the tray for micro green may include a plurality of mini holes. Further, each of the plurality of mini holes may be configured for holding a micro green. Further, the tray for mushroom may include a holder. Further, the holder may be configured for holding a mushroom. Further, each of the tray for plant, the tray for micro green, and the tray for mushroom may include a mist outlet. Further, the mist outlet may be configured for allowing mist to pass from the bottom interior space to the interior space. Further, the plurality of sensors may be configured for generating a plurality of sensor data representing a plurality of variables associated with the interior space. Further, the plurality of sensors may include a camera, a dual function temperature and humidity sensor, and a capacitive sensor. Further, the camera may be configured for capturing images of the plant. Further, the camera may be attached to the inner surface. Further, the field of view of the camera may encompass the interior space. Further, the dual function temperature and a humidity sensor may be configured for receiving an indication of a temperature and a humidity associated with at least one of the interior space and the bottom interior space. Further, the dual function temperature and humidity sensor may be included in the bottom enclosure. Further, the capacitive water level sensor may be configured for receiving an indication of water level in the nutrition container. Further, the capacitive water sensor may be included in the bottom enclosure. Further, the plurality of environmental actuators may be configured for controlling a plurality of environmental variables associated with the interior space. Further, the plurality of environmental actuators may include at least one LED, an LED diffuser, a first piezo pump, a second piezo pump, a heating pad, a heat sink, a cooling fan, and a fan. Further, the at least one LED may be configured for emitting radiation for facilitating growth of the plant. Further, the at least one LED may be included in the top enclosure. Further, the LED diffuser may be optically coupled to the at least one LED. Further, the LED diffuser may be configured for evenly distributing the radiation emitted by the at least one LED. Further, the LED diffuser may be included in the top enclosure. Further, the first piezo pump may be configured for generating mist to facilitate irrigation of the plant. Further, the first piezo pump may be included in the bottom enclosure. Further, the second piezo pump may be configured for generating mist to facilitate control of the temperature and the humidity. Further, the heating pad may be configured for increasing the temperature. Further, the heating pad may be included in the bottom enclosure. Further, the heat sink may be configured for absorbing and transferring heat. Further, the heat sink may be included in the bottom enclosure. Further, the cooling fan may be configured for generating an air flow for the heat transferred by the heat sink. Further, the cooling fan may be included in the bottom enclosure. Further, the fan may be configured for generating an air flow for the mist generated by the first piezo pump. Further, the fan may be mounted on the top inner surface. Further, the fan may be included in the top enclosure. Further, the processing device may be communicatively coupled to the plurality of sensors and the plurality of environmental actuators. Further, the processing device may be configured for controlling the plurality of environmental actuators based on the plurality of sensor data. Further, the processing device may be configured for analyzing the plurality of sensor data using a machine learning model.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is a top right side perspective view of a planting AI automation device, in accordance with some embodiments.

FIG. 2 is a schematic of the bottom LED enclosure, the LED, the camera, and the PCB associated with the device for facilitating cultivation of plants, in accordance with some embodiments.

FIG. 2 is a schematic of the bottom enclosure, the LED, the camera, and the LED PCB associated with the planting AI automation device for facilitating cultivation of plants, in accordance with some embodiments.

FIG. 3 is a schematic of the column support and the main PCB associated with the planting AI automation device for facilitating cultivation of plants, in accordance with some embodiments.

FIG. 4 is a schematic of the tray associated with the planting AI automation device for facilitating cultivation of plants, in accordance with some embodiments.

FIG. 5 is a schematic of the piezo pump irrigation system associated with the planting AI automation device for facilitating cultivation of plants, in accordance with some embodiments.

FIG. 6 is a schematic of the temperature control system associated with the planting AI automation device for facilitating cultivation of plants, in accordance with some embodiments.

FIG. 7 is a schematic of the tray associated with the planting AI automation device for facilitating cultivation of plants, in accordance with some embodiments.

FIG. 8 is a schematic of the tray associated with the planting AI automation device for facilitating cultivation of plants, in accordance with some embodiments.

FIG. 9 is a schematic of the tray associated with the planting AI automation device for facilitating cultivation of plants, in accordance with some embodiments.

FIG. 10 is a schematic of the tray bottom associated with the planting AI automation device for facilitating cultivation of plants, in accordance with some embodiments.

FIG. 11 is a partial view of the tray bottom associated with the planting AI automation device for facilitating cultivation of plants, in accordance with some embodiments.

FIG. 12 is a schematic of the water inlets associated with the planting AI automation device for facilitating cultivation of plants, in accordance with some embodiments.

FIG. 13 is a block diagram of a system for facilitating cultivation of plants using a karpos cultivation AI automation planting device, in accordance with some embodiments.

FIG. 14 is a top right side perspective view of an apparatus, in accordance with some embodiments.

FIG. 15 is a top right side perspective view of the apparatus for facilitating cultivation of plants, in accordance with some embodiments.

FIG. 16 is a bottom perspective view of the top enclosure of the apparatus, in accordance with some embodiments.

FIG. 17 is a top perspective view of the bottom enclosure of the apparatus without tray, in accordance with some embodiments.

FIG. 18 is a bottom perspective view of the tray of the apparatus, in accordance with some embodiments.

FIG. 19 is a top right perspective view of the tray for plant of the apparatus, in accordance with some embodiments.

FIG. 20 is a top right perspective view of the tray for micro green of the apparatus, in accordance with some embodiments.

FIG. 21 is a top right perspective view of the tray for mushroom of the apparatus, in accordance with some embodiments.

FIG. 22 is the bottom left side perspective view of the bottom enclosure of apparatus without the bottom outer surface, in accordance with some embodiments.

FIG. 23 is the top left side perspective view of the bottom enclosure of apparatus, in accordance with some embodiments.

FIG. 24 is a block diagram of the plurality of sensors of the apparatus, in accordance with some embodiments.

FIG. 25 is a block diagram of the plurality of environmental actuators of the apparatus, in accordance with some embodiments.

FIG. 26 is a top right side perspective view of an apparatus for facilitating cultivation of plants, in accordance with some embodiments.

FIG. 27 is top right side perspective view of an apparatus for facilitating cultivation of plants.

FIG. 28 is a front right side perspective view of a karpos cultivation AI automation planting device for facilitating cultivation of plants, in accordance with some embodiments.

FIG. 29 is a bottom rear right side perspective view of the karpos cultivation AI automation planting device for facilitating cultivation of plants, in accordance with some embodiments.

FIG. 30 is a front view of the karpos cultivation AI automation planting device for facilitating cultivation of plants, in accordance with some embodiments.

FIG. 31 is a rear view of the karpos cultivation AI automation planting device for facilitating cultivation of plants, in accordance with some embodiments.

FIG. 32 is a right side view of the karpos cultivation AI automation planting device for facilitating cultivation of plants, in accordance with some embodiments.

FIG. 33 is a left side view of the karpos cultivation AI automation planting device for facilitating cultivation of plants, in accordance with some embodiments.

FIG. 34 is a top view of the karpos cultivation AI automation planting device for facilitating cultivation of plants, in accordance with some embodiments.

FIG. 35 is a bottom view of the karpos cultivation AI automation planting device for facilitating cultivation of plants, in accordance with some embodiments.

FIG. 36 is a block diagram of a system for facilitating cultivation of plants using a karpos cultivation AI automation planting device, in accordance with some embodiments.

FIG. 37 is a flow chart of a method for facilitating cultivation of plants using a karpos cultivation AI automation planting device, in accordance with some embodiments.

FIG. 38 is an illustration of an online platform consistent with various embodiments of the present disclosure.

FIG. 39 is a block diagram of a computing device for implementing the methods disclosed herein, in accordance with some embodiments.

### DETAILED DESCRIPTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of systems, method, apparatuses, and devices for facilitating cultivation of plants, embodiments of the present disclosure are not limited to use only in this context.

In general, the method disclosed herein may be performed by one or more computing devices. For example, in some embodiments, the method may be performed by a server computer in communication with one or more client devices over a communication network such as, for example, the Internet. In some other embodiments, the method may be performed by one or more of at least one server computer, at least one client device, at least one network device, at least one sensor and at least one actuator. Examples of the one or more client devices and/or the server computer may include, a desktop computer, a laptop computer, a tablet computer, a personal digital assistant, a portable electronic device, a wearable computer, a smart phone, an Internet of Things (IoT) device, a smart electrical appliance, a video game console, a rack server, a super-computer, a mainframe computer, mini-computer, micro-computer, a storage server, an application server (e.g. a mail server, a web server, a real-time communication server, an FTP server, a virtual server, a proxy server, a DNS server etc.), a quantum computer, and so on. Further, one or more client devices and/or the server computer may be configured for executing a software application such as, for example, but not limited to, an operating system (e.g. Windows, Mac OS, Unix, Linux, Android, etc.) in order to provide a user interface (e.g. GUI, touch-screen based interface, voice based interface, gesture based interface etc.) for use by the one or more users and/or a network interface for communicating with other devices over a communication network. Accordingly, the server computer may include a processing device configured for performing data processing tasks such as, for example, but not limited to, analyzing, identifying, determining, generating, transforming, calculating, computing, compressing, decompressing, encrypting, decrypting, scrambling, splitting, merging, interpolating, extrapolating, redacting, anonymizing, encoding and decoding. Further, the server computer may include a communication device configured for communicating with one or more external devices. The one or more external devices may include, for example, but are not limited to, a client device, a third party database, public database, a private database and so on. Further, the communication device may be configured for communicating with the one or more external devices over one or more communication channels. Further, the one or more communication channels may include a wireless communication channel and/or a wired communication channel. Accordingly, the communication device may be configured for performing one or more of transmitting and receiving of information in electronic form. Further, the server computer may include a storage device configured for performing data storage and/or data retrieval operations. In general, the storage device may be configured for providing reliable storage of digital information. Accordingly, in some embodiments, the storage device may be based on technologies such as, but not limited to, data compression, data backup, data redundancy, deduplication, error correction, data finger-printing, role based access control, and so on.

Further, one or more steps of the method disclosed herein may be initiated, maintained, controlled and/or terminated based on a control input received from one or more devices operated by one or more users such as, for example, but not limited to, an end user, an admin, a service provider, a service consumer, an agent, a broker and a representative thereof. Further, the user as defined herein may refer to a human, an animal or an artificially intelligent being in any state of existence, unless stated otherwise, elsewhere in the present disclosure. Further, in some embodiments, the one or more users may be required to successfully perform authentication in order for the control input to be effective. In general, a user of the one or more users may perform authentication based on the possession of a secret human readable secret data (e.g. username, password, passphrase, PIN, secret question, secret answer etc.) and/or possession of a machine readable secret data (e.g. encryption key, decryption key, bar codes, etc.) and/or or possession of one or more embodied characteristics unique to the user (e.g. biometric variables such as, but not limited to, fingerprint, palm-print, voice characteristics, behavioral characteristics, facial features, iris pattern, heart rate variability, evoked potentials, brain waves, and so on) and/or possession of a unique device (e.g. a device with a unique physical and/or chemical and/or biological characteristic, a hardware device with a unique serial number, a network device with a unique IP/MAC address, a telephone with a unique phone number, a smartcard with an authentication token stored thereupon, etc.). Accordingly, the one or more steps of the method may include communicating (e.g. transmitting and/or receiving) with one or more sensor devices and/or one or more actuators in order to perform authentication. For example, the one or more steps may include receiving, using the communication device, the secret human readable data from an input device such as, for example, a keyboard, a keypad, a touch-screen, a microphone, a camera and so on. Likewise, the one or more steps may include receiving, using the communication device, the one or more embodied characteristics from one or more biometric sensors.

Further, one or more steps of the method may be automatically initiated, maintained and/or terminated based on one or more predefined conditions. In an instance, the one or more predefined conditions may be based on one or more contextual variables. In general, the one or more contextual variables may represent a condition relevant to the performance of the one or more steps of the method. The one or more contextual variables may include, for example, but are not limited to, location, time, identity of a user associated with a device (e.g. the server computer, a client device etc.) corresponding to the performance of the one or more steps, environmental variables (e.g. temperature, humidity, pressure, wind speed, lighting, sound, etc.) associated with a device corresponding to the performance of the one or more steps, physical state and/or physiological state and/or psychological state of the user, physical state (e.g. motion, direction of motion, orientation, speed, velocity, acceleration, trajectory, etc.) of the device corresponding to the performance of the one or more steps and/or semantic content of data associated with the one or more users. Accordingly, the one or more steps may include communicating with one or more sensors and/or one or more actuators associated with the one or more contextual variables. For example, the one or more sensors may include, but are not limited to, a timing device (e.g. a real-time clock), a location sensor (e.g. a GPS receiver, a GLONASS receiver, an indoor location sensor etc.), a biometric sensor (e.g. a fingerprint sensor), an environmental variable sensor (e.g. temperature sensor, humidity sensor, pressure sensor, etc.) and a device state sensor (e.g. a power sensor, a voltage/current sensor, a switch-state sensor, a usage sensor, etc. associated with the device corresponding to performance of the or more steps).

Further, the one or more steps of the method may be performed one or more number of times. Additionally, the one or more steps may be performed in any order other than as exemplarily disclosed herein, unless explicitly stated otherwise, elsewhere in the present disclosure. Further, two or more steps of the one or more steps may, in some embodiments, be simultaneously performed, at least in part. Further, in some embodiments, there may be one or more time gaps between performance of any two steps of the one or more steps.

Further, in some embodiments, the one or more predefined conditions may be specified by the one or more users. Accordingly, the one or more steps may include receiving, using the communication device, the one or more predefined conditions from one or more and devices operated by the one or more users. Further, the one or more predefined conditions may be stored in the storage device. Alternatively, and/or additionally, in some embodiments, the one or more predefined conditions may be automatically determined, using the processing device, based on historical data corresponding to performance of the one or more steps. For example, the historical data may be collected, using the storage device, from a plurality of instances of performance of the method. Such historical data may include performance actions (e.g. initiating, maintaining, interrupting, terminating, etc.) of the one or more steps and/or the one or more contextual variables associated therewith. Further, machine learning may be performed on the historical data in order to determine the one or more predefined conditions. For instance, machine learning on the historical data may determine a correlation between one or more contextual variables and performance of the one or more steps of the method. Accordingly, the one or more predefined conditions may be generated, using the processing device, based on the correlation.

Further, one or more steps of the method may be performed at one or more spatial locations. For instance, the method may be performed by a plurality of devices interconnected through a communication network. Accordingly, in an example, one or more steps of the method may be performed by a server computer. Similarly, one or more steps of the method may be performed by a client computer. Likewise, one or more steps of the method may be performed by an intermediate entity such as, for example, a proxy server. For instance, one or more steps of the method may be performed in a distributed fashion across the plurality of devices in order to meet one or more objectives. For example, one objective may be to provide load balancing between two or more devices. Another objective may be to restrict a location of one or more of an input data, an output data and any intermediate data therebetween corresponding to one or more steps of the method. For example, in a client-server environment, sensitive data corresponding to a user may not be allowed to be transmitted to the server computer. Accordingly, one or more steps of the method operating on the sensitive data and/or a derivative thereof may be performed at the client device.

Overview:

The present disclosure describes systems, methods, apparatuses, and devices for facilitating cultivation of plants.

Further, the present disclosure describes methods and systems for facilitating cultivation of plants using a karpos cultivation AI automation planting device. Further, the disclosed system may include a planting AI automation device with a mist and temperature control irrigation system (Eden).

Further, the disclosed system may be configured for using real-time dynamic (or adaptive) automated control to grow plants. Further, the disclosed system may use microprocessors and hardware that interfaces with WiFi, Mobile Applications, and AI through internet control. Further, the disclosed control system may work offline independently as well. Further, the control system may control light intensity, light on/off time, fluid (including nutrition fluid and water) irrigation, humidity, and internal temperature. Further, the disclosed system may use LED lights with specific wavelengths to maximize the growth rate of plants. Further, the disclosed system may include an LED light with infra-red light to warm up the temperature with or without the enclosure. Further, the disclosed system may be configured for using and dynamically adjusting a variety of LED combinations to meet different plants' growth needs and user preferences. Further, the disclosed system may include capacitive sensors to detect the water level of the water tank to notify users to refill the water tank. The capacitive sensor may detect and report multiple segments of water level. Further, the disclosed system may include a semiconductor cooling pad that can increase or decrease the temperature of the water tank. Further, the disclosed system may include a piezo pump(s) to draw water from the water tank and generate mist for irrigation. Further, the piezo pump(s) generates mist from the water tank. The mist may irrigate the root of the plant including herbs, flowers, micro-green, and mushrooms. The mist may also control the temperature inside the water tank, working along with the semiconductor cooling pad. Further, the piezo pump(s) may include the secondary pump(s) that generates mist with the water from the water tank. The mist may irrigate above the root of the plant. The mist may also control the ambient temperature and humidity during the growth process. Further, the disclosed system may include a temperature control system including a heat sink, a fan system, and a semiconductor cooling or heating pad. Further, the temperature control system controls the temperature inside the water tank. Further, the disclosed system may include a humidity control system including mist, LED lights, and a fan system. The humidity control system controls the humidity inside the plant tank with a glass or plastic cover. The mist may be generated by the piezo pump including the secondary piezo pump. Further, the secondary piezo pump may generate mist from a water tank with a higher or lower temperature than the ambient temperature. Further, the secondary piezo pump may facilitate air circulation to enhance plant growth. Further, the disclosed system may include a glass or plastic enclosure to maintain temperature and humidity to provide an optimized environment for plant growth. This glass or plastic enclosure material may include tinted color. Further, the disclosed system may include a tinted glass or tinted plastic enclosure to block light from outside of the enclosure. Further, the disclosed system may include a camera and proprietary online AI model and service associated with the disclosed system to monitor, control, diagnose plant health, and predict the growth rate of the plant. Further, the camera may record the growth of the plant. Further, the disclosed system may use WIFI to connect to the Internet for AI control. Further, the disclosed system may use Bluetooth to connect the mobile phone to the Internet for AI control. Further, the disclosed system may synchronize light intensity, light temperature, light combination, water timing, temperature control, and humidity control based on the AI model.

Further, the disclosed system may be configured for monitoring the health of the plant and notifying users based on the AI model. Further, the camera may collect and learn plant data to enhance the AI algorithm. Further, the disclosed system may be associated with a software platform, EDEN. Further, the disclosed system may connect to Eden's APP through Bluetooth or WiFi. Further, the software platform (or App) may provide GIF (motion video) of the plant. The app may generate a video or GIF animation using pictures captured during the growing process of a plant. Further, the software platform may be associated with a social media platform. Further, the software platform may be associated with market sales.

Further, the present disclosure describes a method for facilitating cultivation of plants using a karpos cultivation AI automation planting device. Further, the method may include receiving, using a communication device, plant data from at least one input device. Further, the method may include analyzing, using a processing device, the plant data based on a machine learning model. Further, the method may include determining, using the processing device, a plant growth status based on the analyzing. Further, the method may include processing, using the processing device, and the plant growth status. Further, the method may include generating, using the processing device, an action alert based on the processing. Further, the method may include transmitting, using the communication device, the action alert to the karpos cultivation AI automation planting device. Further, the method may include transmitting, using the communication device, the action alert, the plant data, and the plant growth status to at least one user device. Further, the method may include storing, using a storage device, the action alert, the plant data, and the plant growth status.

Further, the present disclosure describes a system for facilitating cultivation of plants using a karpos cultivation AI automation planting device. Further, the system may include a communication device configured for receiving plant data from at least one input device. Further, the communication device may be configured for transmitting an action alert to the karpos cultivation AI automation planting device. Further, the communication device may be configured for transmitting the action alert, the plant data, and a plant growth status to at least one user device. Further, the system may include a processing device configured for analyzing the plant data based on a machine learning model. Further, the processing device may be configured for determining the plant growth status based on the analyzing. Further, the processing device may be configured for processing the plant growth status. Further, the processing device may be configured for generating the action alert based on the processing. Further, the system may include a storage device configured for storing the action alert, the plant data, and the plant growth status.

Further, the present disclosure describes methods and systems for facilitating cultivation of plants using a karpos cultivation AI automation planting device

Further, the present disclosure relates generally to planting. More specifically, the present disclosure describes methods and systems for facilitating cultivation of plants using a karpos cultivation AI automation planting device.

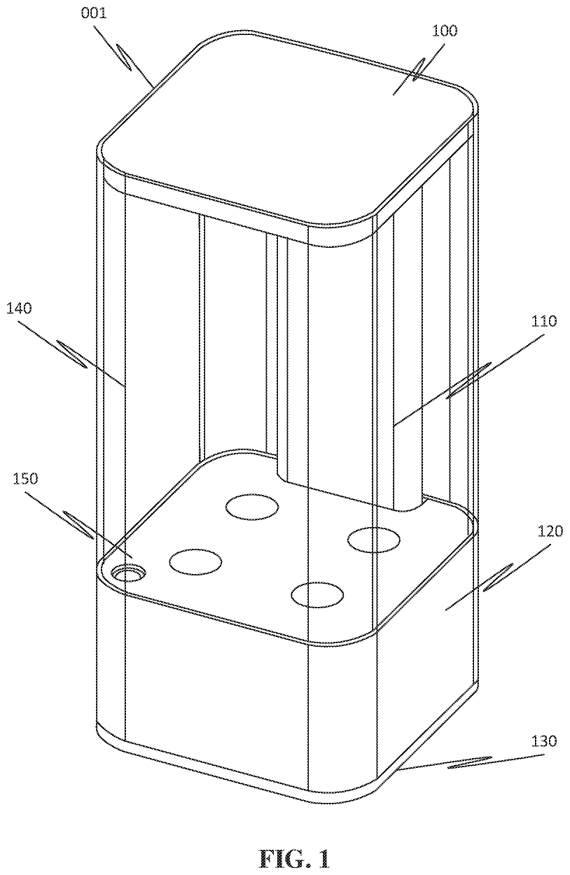

FIG. 1 is a top right side perspective view of a planting AI automation device [001], in accordance with some embodiments. Accordingly, the planting AI automation device [001] may include a top enclosure [100] that may protect LEDs, camera(s), and electronics. Further, the top enclosure [100] may provide a mechanical connection to a vertical column [110] of the planting AI automation device [001]. Further, the planting AI automation device [001] may include the vertical column [110] that may provide support to the top enclosure [100]. Further, the planting AI automation device [001] may include a bottom enclosure [120] that may provide base support to the vertical column [110] and store other internal components. Further, the planting AI automation device [001] may include a base support [130] that may support the bottom enclosure [120]. Further, the planting AI automation device [001] may include a glass or plastic cover [140] that may maintain temperature, humidity, and light intensity inside the enclosure. Further, the planting AI automation device [001] may include a tray [150] for plants that may hold plants including herbs, edibles, flowers, micro-green, and mushrooms. Further, the planting AI automation device [001] may include a LED diffuser (Fresnel lens) [160] that may distract and may direct light to the plant. Further, the planting AI automation device [001] may include a LED PCB [200] that may provide wire connection and electronic control to LEDs and camera(s) [220]. Further, the planting AI automation device [001] may include LEDs [210] that may emit UV, IR, and visual light wavelength to grow a plant. Further, the planting AI automation device [001] may include a camera [220] that may capture pictures of the plants for AI analysis. Further, the pictures captured by the camera [220] may be processed to generate content using an APP associated with the planting AI automation device [001]. Further, the APP the allows sharing of the pictures on social media. Further, the content may include GIFs, videos, images, etc. Further, the planting AI automation device [001] may include a fan [230] that may circulate air inside the enclosure, an exemplary embodiment of the disclosed device [001] herein. Further, the planting AI automation device [001] may include a main PCB [300] that may provide the main control for an AI control system associated with the planting AI automation device [001] and a wireless interface with the APP and the Internet. Further, the planting AI automation device [001] may include a second tray [400] for the plant that may provide a growing platform for the plant. Further, the planting AI automation device [001] may include a first piezo pump [500] for plant irrigation that may generate mist to irrigate the root of the plant. Further, the planting AI automation device [001] may include a second piezo pump [510] that may generate mist to control temperature, control humidity, and irrigate plants including mushrooms. Further, the planting AI automation device [001] may include containers [520] that may hold the plant including herbs, edibles, and flowers. Further, the planting AI automation device [001] may include a water container [530] that may store water for water irrigation and plant nutrition fluid or powder. Further, the planting AI automation device [001] may include a dual function temperature and humidity sensor [540] that may provide measured information for the AI control system to control and enhance plant growth. Further, the planting AI automation device [001] may include a heat sink [600] that may absorb and transfer heat from a semi-conductor cooling or heating pad [610]. Further, the planting AI automation device [001] may include the semi-conductor cooling or heating pad [610] that may lower or increase temperature. Further, the planting AI automation device [001] may include a cooling fan [620] that may generate airflow to direct heat from the heat sink [600] to the external of the device [001]. Further, the planting AI automation device [001] may include venting holes [630] that may allow hot air to be dissipated to the external of the device [001]. Further, the planting AI automation device [001] may include a capacitive water level sensor [640] that may measure the water level of the water container [530]. Further, the planting AI automation device [001] may include a tray [700a] for a plant that may secure plants including herbs, edibles, and flowers. Further, the planting AI automation device [001] may include a tray [700b] for micro-green that may secure micro-green and another plant that may fit. Further, the planting AI automation device [001] may include a tray [700c] for a mushroom that may secure mushrooms and other plants that may fit. Further, the planting AI automation device [001] may include a tray bottom [750] that may have fins to guide the flow path of mist. Further, the planting AI automation device [001] may include a tray [760] that may have a downward slope to guide water into the containers [520] to hold the plant. Further, the planting AI automation device [001] may include a tray [770] that may have a water inlet to fill the water container [530].

This design describes a real-time automated control device for the plant including edible, herbs, general plants, flowers, micro-green, and mushrooms. This design includes the mechanical enclosures including [100] top enclosure, [110] vertical column, [120] bottom enclosure, [130] base support, [140] glass or plastic cover, and [150] tray for the plant.

Further, the top enclosure [100], the vertical column [110], the bottom enclosure [120], and the tray [150] for the plant may be made with polycarbonate, ABS, other plastic resin, or aluminum, stainless steel, metal alloy, or other materials. Further, the base support [130] may be made of polycarbonate, ABS, other plastic resin, wood, or other materials. Further, the base support [130] may also cover with leather, suede, soft-touch paint. Further, the top enclosure [100], the vertical column [110], the bottom enclosure [120], and the base support [130] may be assembled and secured together by screws, mechanical latches, adhesive or friction fit. Further, the glass or plastic cover [140] may be made of glass, polycarbonate, polyolefin, transparent, translucent plastic, and other similar material. The glass or plastic cover [140] may slide and sit on top of the bottom enclosure [120]. Further, the glass or plastic cover [140] may be tinted with a dark color or use coating to optically block or minimize visible light from the outside. Further, the glass or plastic cover [140] may be used to isolate external ambient light, humidity, and temperature from the light, humidity, and temperature inside the cover [140]. Further, the tray [150] for the plant sits on top of the bottom enclosure [120]. There are different variations including the tray [700a] for the plant, the tray [700b] for micro-green, and the tray [700c] for the mushroom to accommodate a different kind of plant. Further, the top enclosure [100] includes an assembly underneath. The top enclosure [100] includes the LED PCB [200] and [160] LED diffuser. The LEDs [210] include one or more LEDs that may emit light in a wide range of light spectrum to enhance the growth rate of the plant. The light spectrum includes infra-red, UV, and visible wavelengths. The infra-red LED also provides a heating function for this design [100]. Further, the LED PCB [200] includes the LEDs [210], the camera [220], the processor, and other electronics. Further, the LED PCB [200] may be mounted to the top enclosure [100] by screws. Further, the camera [220] may be used to record the images of the plant. The camera [220] provides social media entertainment and images for AI analysis which determines the automated control of the planting AI automation device [001]. The AI analysis may include the analysis of the growing size change of the plant, color change of the plant, fruit detection, and abnormal shape and color of the plant. Further, the camera [220] may be mounted on the [220] LED PCB. Further, the camera [220] may capture pictures from the top of the plant. The camera [220] may be mounted at other angles. Multiple cameras may be used also. Further, the fan [230] may be used to circulate and exhaust air from the inside of the enclosure to the outside of the planting AI automation device [001]. The air circulation may enhance the growth of mushrooms. The LED diffuser [160] may protect PCB components. The LED diffuser [160] also integrates a Fresnel lens or another lens to focus LEDs light [210] into a specific area underneath the LEDs [210]. Further, the light may effectively focus on the plant and reduce the power consumption of the planting AI automation device [001]. Further, the LED diffuser [160] may be mounted by screws, latches, or glue to the top enclosure [100]. Further, the vertical support [110] may include the main PCB [300] mounted inside. The main PCB [300] includes the function of WiFi, hardware control, piezo pump drivers, LED PCB controls, power controls, the dual function of temperature and humidity sensor control, semi-conductor cooling/heating pad control, cooling fan control, and other electrical components within the planting AI automation device [001]. Further, the tray [400] may support the plant which grows by the device [001]. It evolves into other variations so all other types of plants can be mounted. Further, in some embodiments, the planting AI automation device [001] may include the tray [700a] for the plant, the tray [700b] for micro-green, and the tray [700c] for the mushroom. The trays can be used for edible plants, herbs, general plants, flowers, micro-green, mushrooms, etc. Further, the planting AI automation device [001] may include more than one [400] tray. This may include a few trays to stack on top of each other. Further, the planting AI automation device [001] may include the water irrigation system that contains the piezo pumps [500] [510], the water container [530], and the containers [520] to hold the plant. The piezo pump [500] generates mist or fog to irrigate the root of the plant. The second piezo pump [510] generates mist or fog to irrigate the plant above the root. The second piezo pump [510] may also control the temperature and humidity in the grow environment including the designed enclosure [140]. The water container [530] stores the water and nutrition fluid or powder. The piezo pumps [500] [510] may absorb water from the water tank [530] through a capillary or wicking effect with a cotton stick(s). The dual function temperature and humidity sensor [540] measures the ambient temperature around or inside the designed enclosure [140] and measures the humidity. This sensor [540] provides real-time feedback for the planting AI automation device [001] to increase or decrease the temperature or increase or decrease humidity to optimize the growth of the plant. The containers [520] are used to hold the plant in place so the root of the plant can access the water inside the water tank [530]. The containers [520] may have openings on top so the plant can grow upward. The planting AI automation device [001] may have one or multiple containers [520]. The planting AI automation device [001] may have one or more than two piezo pumps [500] [510]. The first piezo pump [500] and the second piezo pump [510] may position at the center, corner, and other locations of the tray [400]. The planting AI automation device [001] may include a temperature control system including the heat sink [600], the semi-conductor cooling or heating pad [610], the cooling fan [620], and the venting holes [630]. The semi-conductor cooling or heating pad [610] is attached to the water container [530] with a thermally conductive silicone pad or thermally conductive paste to enhance thermal conductivity. When electrical current passes through the semiconductor cooling or heating pad [610], the semi-conductor increases or decreases in temperature. The temperature conducts to the water container [530]. The water inside the water container [530] is cooled down or heated up or stays the same by the temperature control of the semi-conductor cooling or heating pad [610]. The semi-conductor cooling or heating pad [610] requires the heat sink [600] to absorb heat. The heat sink [600] includes a metal fin so heat can be dissipated by convection. The cooling fan [620] creates airflow to pass through the heat sink [600] and bring hot air to the outside through the venting holes [630]. The capacitive water level sensor [640] monitors the water level inside the water tank [530]. When the water level is low, the capacitive level sensor [640] senses when water is near empty or when water is at a different level and provides real-time feedback to the device [001]. The planting AI automation device [001] can send feedback to the APP. Further, the tray [400] for the plant may have a variation design including the tray [700a] for a plant, the tray [700b] for micro-green, and the tray [700c] for a mushroom. Further, the tray [700a] for the plant have the plant holder(s) [720] to hold different type of plants including herbs, flowers, and any plant. The tray [400] also has an opening [710] for the mist outlet. This opening [710] allows the piezo pump [510] to evolve the mist or fog into the grow enclosure or grow environment. Further, the tray [700b] for micro-green has mini-holes [730] to hold and grow micro-green. Further, the tray [700c] for mushroom has the holder [740] for mushroom. The bottom of the tray [750] may include fins to guide the flow path of mist. The fins may be constructed in a curve shape so mist may travel in a curvature path and create circulated flow in the enclosure. The curvature [760] of the tray may have a downward slope to collect the mist condensation into the containers [520] that hold the plant. Further, the tray may contain water inlet(s) [770] to fill the water container [530]. The water inlet [770] may have an inclined surface to guide water into the water container. The water inlet [770] may extend outside the tray [400] for the plant such that the opening may minimize the amount of light to get into the water container [530]. Further, the planting AI automation device [001] may comprise a means of receiving data from the mobile phone(s) or tablet(s) [820] through the internet router [810] directly or through the Internet. The planting AI automation device [001] may further comprise a means of being controlled by the mobile phone or tablet [820] through the internet router [810] or the internet. The planting AI automation device [001] may further comprise a means of sending data, storing, and/or processing data. This planting AI automation device [001] may further comprise a means for sending liquid usage status data and image(s) of the plant.

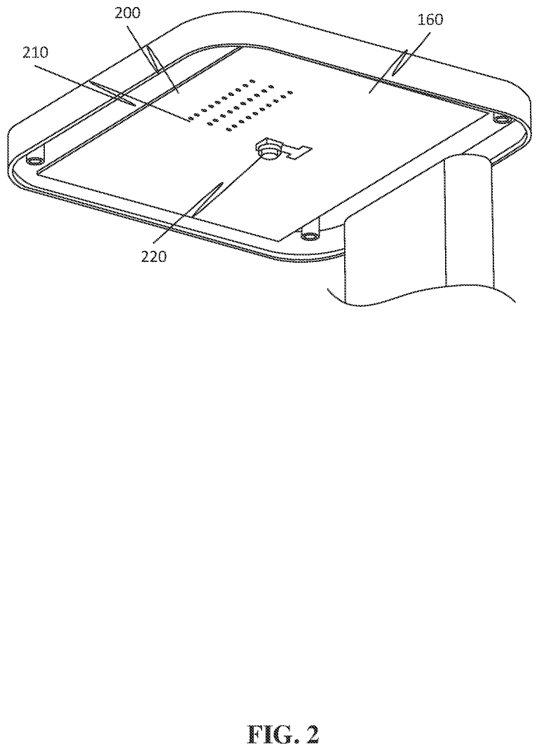

FIG. 2 is a schematic of the bottom enclosure [120], the LED [210], the camera [220], and the LED PCB [200] associated with the planting AI automation device for facilitating cultivation of plants, in accordance with some embodiments.

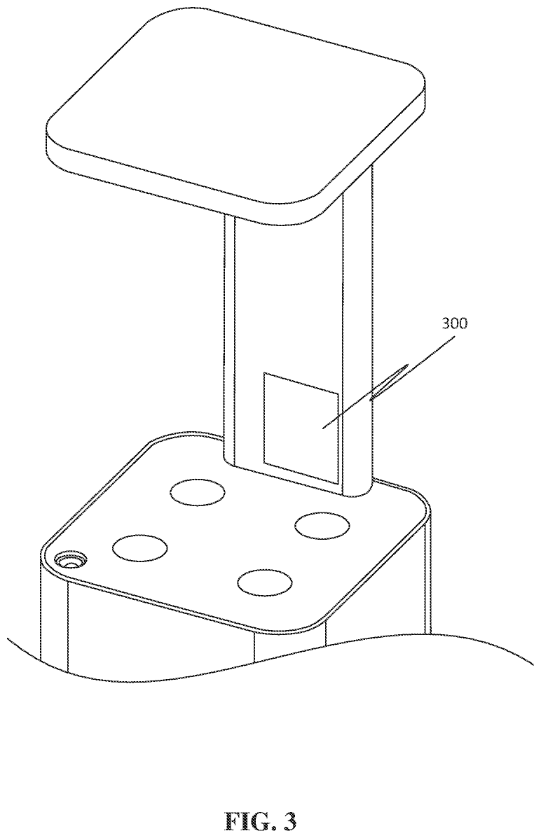

FIG. 3 is a schematic of the column support and the main PCB [300] associated with the planting AI automation device [001] for facilitating cultivation of plants, in accordance with some embodiments.

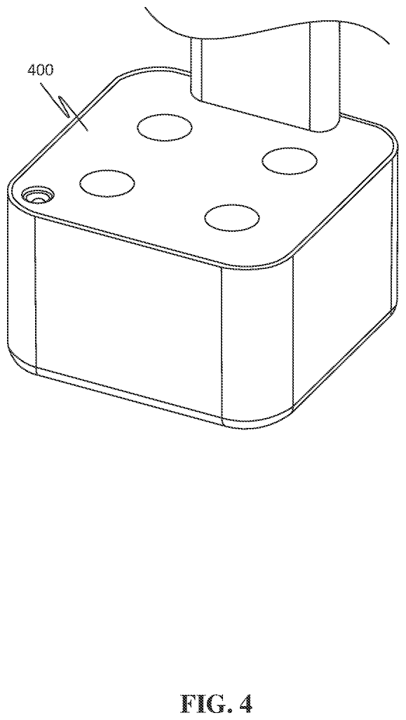

FIG. 4 is a schematic of the tray [150] associated with the planting AI automation device [001] for facilitating cultivation of plants, in accordance with some embodiments.

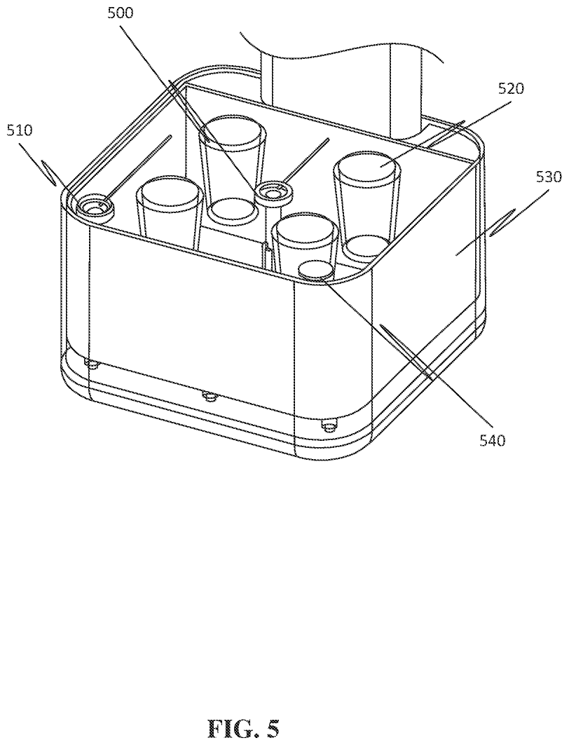

FIG. 5 is a schematic of the piezo pump irrigation system associated with the planting AI automation device [001] for facilitating cultivation of plants, in accordance with some embodiments.

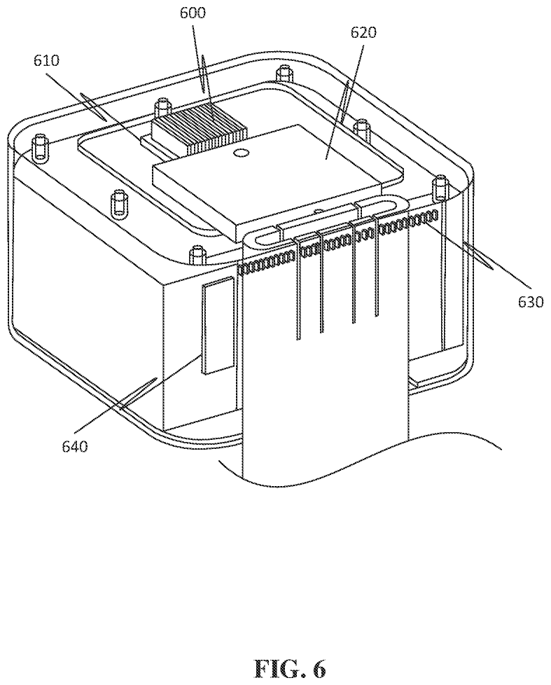

FIG. 6 is a schematic of the temperature control system associated with the planting AI automation device [001] for facilitating cultivation of plants, in accordance with some embodiments.

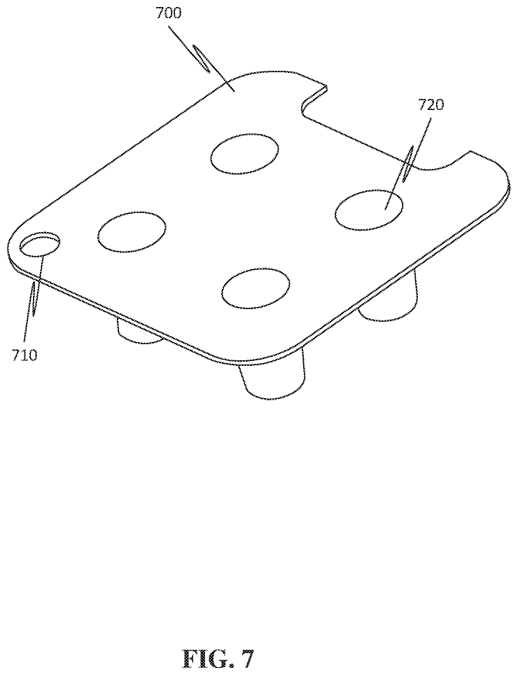

FIG. 7 is a schematic of the tray [700a] associated with the planting AI automation device [001] for facilitating cultivation of plants, in accordance with some embodiments.

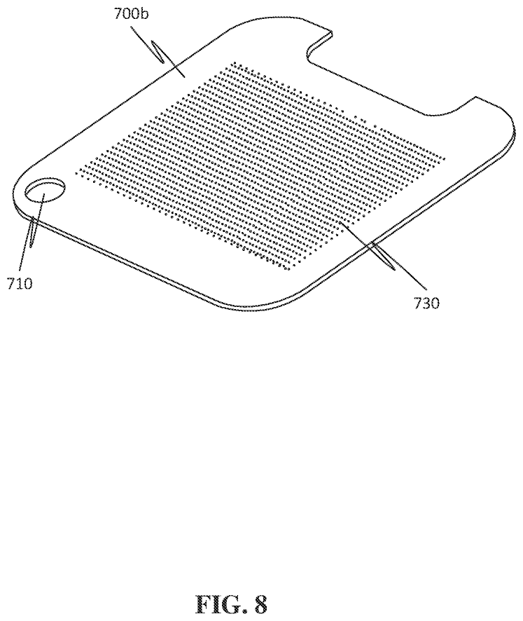

FIG. 8 is a schematic of the tray [700b] associated with the planting AI automation device [001] for facilitating cultivation of plants, in accordance with some embodiments.

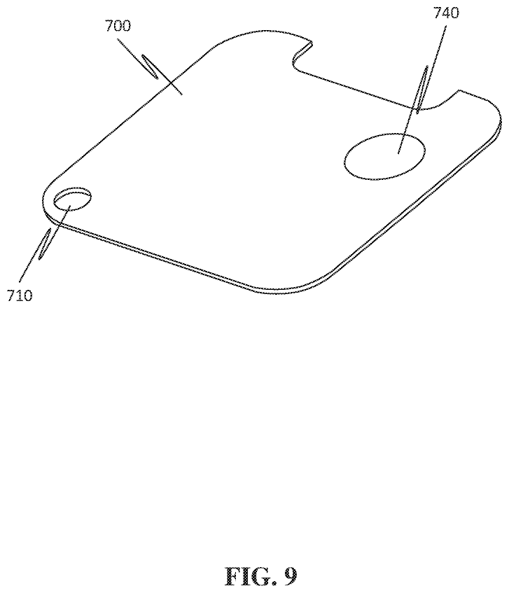

FIG. 9 is a schematic of the tray [700c] associated with the planting AI automation device [001] for facilitating cultivation of plants, in accordance with some embodiments.

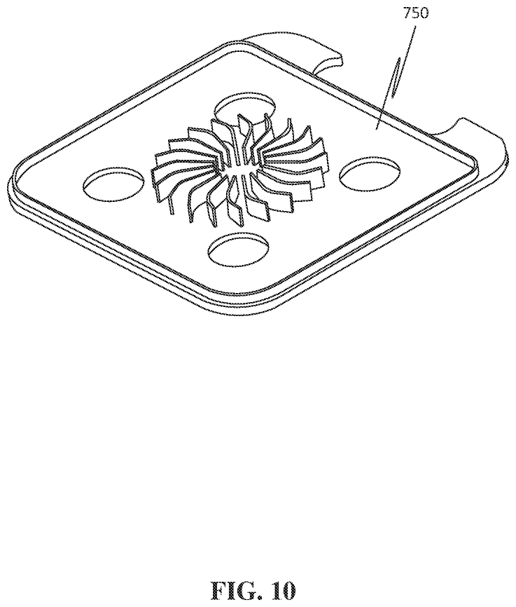

FIG. 10 is a schematic of the tray bottom [750] associated with the planting AI automation device [001] for facilitating cultivation of plants, in accordance with some embodiments.

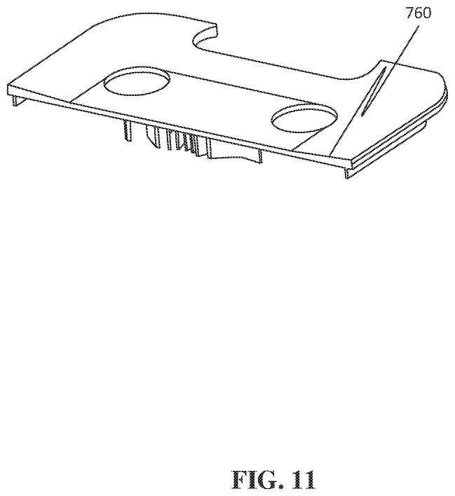

FIG. 11 is a partial view of the tray bottom [750] associated with the planting AI automation device [001] for facilitating cultivation of plants, in accordance with some embodiments.

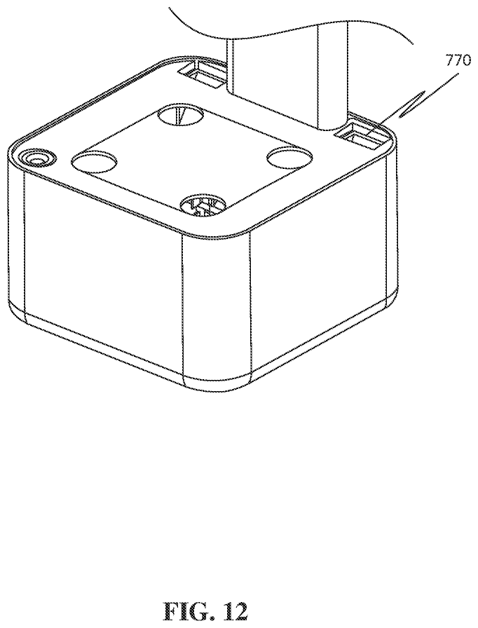

FIG. 12 is a schematic of the water inlets associated with the planting AI automation device [001] for facilitating cultivation of plants, in accordance with some embodiments.

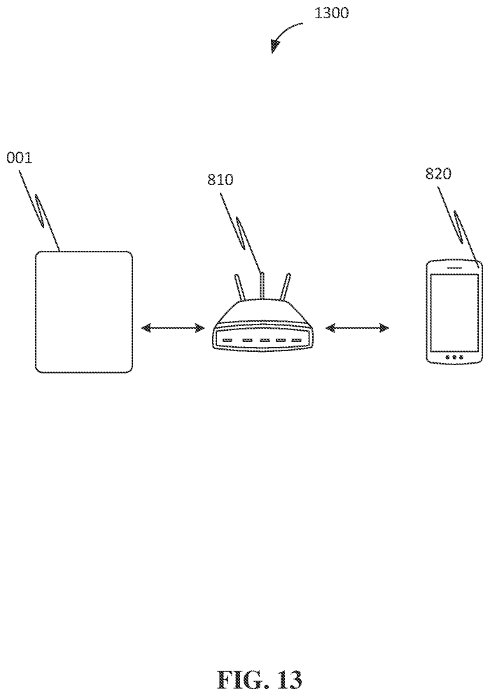

FIG. 13 is a block diagram of a system 1300 for facilitating cultivation of plants using a karpos cultivation AI automation planting device [001], in accordance with some embodiments. Accordingly, the system 1300 may include an internet router [810] that may connect to the karpos cultivation AI automation planting device [001], a mobile phone [820], or a tablet to the Internet to access the karpos cultivation AI automation planting device [001]. Further, the mobile phone or tablet [820] may connect to the internet including the cloud to access the karpos cultivation AI automation planting device [001].

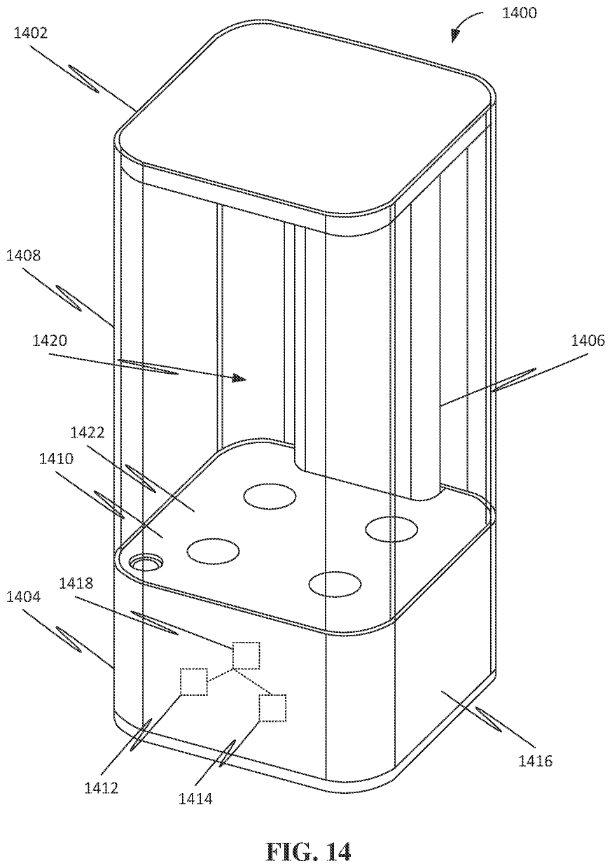

FIG. 14 is a top right side perspective view of an apparatus 1400, in accordance with some embodiments. Further, the apparatus 1400 may be the planting AI automation device [001]. Accordingly, the apparatus may include a top enclosure 1402, a bottom enclosure 1404, a vertical column 1406, a cover 1408, a tray 1410, a plurality of sensors 1412, a plurality of environmental actuators 1414, a nutrition container 1416, and a processing device 1418.

Further, the top enclosure 1402 may be configured for housing at least one first component. Further, the at least one first component may include at least one of at least one LED 1606, at least one first piezo pump 1710, etc.

Further, the bottom enclosure 1404 may be configured for housing at least one second component. Further, the at least second component may include a camera 1604, a dual function temperature and humidity sensor 1708, etc.

Further, the vertical column 1406 may be interspersed between the top enclosure 1402 and the bottom enclosure 1404 may be forming an interior space 1420 therebetween.

Further, the cover 1408 may be interspersed between the top enclosure 1402 and the bottom enclosure 1404. Further, the cover 1408 may be configured for enclosing the interior space 1420. Further, the cover 1408 may be configured for allowing light to enter from a surrounding of the apparatus 1400 into the interior space 1420.

Further, the tray 1410 may be configured for holding a plant.

Further, the plurality of sensors 1412 may be configured for generating a plurality of sensor data representing a plurality of variables associated with the interior space 1420. Further, the plurality of variables may include temperature, humidity, light, pressure, etc.

Further, the plurality of environmental actuators 1414 may be configured for controlling a plurality of environmental variables associated with the interior space 1420. Further, the plurality of environmental variables may include temperature, humidity, light, pressure, etc.

Further, the nutrition container 1416 may be configured for containing a nutritional medium. Further, the nutritional medium may include a nutrient powder, a nutrient liquid, soil, an aqueous solution of plant nutrients (nitrogen (N), phosphorus (P), potassium (K), Molybdenum (Mo), Zinc (Zn), Copper (Cu), etc.), a growth media for plants with the plant nutrients, etc.

Further, the processing device 1418 may be communicatively coupled to the plurality of sensors 1412 and the plurality of environmental actuators 1414. Further, the processing device 1418 may be configured for controlling the plurality of environmental actuators 1414 based on the plurality of sensor data. Further, in an instance, the processing device 1418 may be configured for analyzing the plurality of sensor data. Further, the processing device 1418 may be configured for determining a status of the plant based on the analyzing. Further, the processing device 1418 may be configured for generating a plurality of commands for the plurality of actuators based on the determining. Further, the plurality of environmental actuators 1414 may perform a plurality of operations based on the plurality of commands. Further, the plurality of operations may include maintaining a specific temperature, a specific pressure, a specific light, a specific humidity, etc.

Further, in some embodiments, the vertical column 1406 may include a plurality of fasteners 1508-1510. Further, the plurality of fasteners 1508-1510 may include a friction clasp, etc. disposed on either end of the vertical column 1406. Further, the plurality of fasteners 1508-1510 may be configured for detachably coupling the vertical column 1406 to each of the top enclosure 1402 and the bottom enclosure 1404.

Further, in some embodiments, the top enclosure 1402 may include a top outer surface 1502 and a top inner surface 1602. Further, the top outer surface 1502 may be opposed to the top inner surface 1602. Further, the bottom enclosure 1404 may include a bottom inner surface 1702 and a bottom outer surface 1704 such that the bottom inner surface 1702 opposes the top inner surface 1602. Further, the cover 1408 may be removably attached to a bottom periphery 1504 of the bottom inner surface 1702 using a friction clasp 1506.

Further, in an embodiment, the tray 1410 may include a tray top surface 1422 and a tray bottom surface 1802. Further, the tray bottom surface 1802 may include fins 1804. Further, the fins 1804 may be configured for guiding a flow of mist. Further, the tray 1410 may include a tray for plant 1902, a tray for micro green 2002, and a tray for mushroom 2102. Further, the tray for plant 1902 may include at least one plant holder 1904. Further, the at least one plant holder 1904 may be configured for holding a plant. Further, the tray for micro green 2002 may include a plurality of mini holes 2004. Further, in an instance, the plurality of mini holes 2004 may include a plurality of cavities configured for holding the micro green. Further, each of the plurality of mini holes 2004 may be configured for holding the micro green. Further, the tray for mushroom 2102 may include a holder 2104. Further, the holder 2104 may be configured for holding a mushroom. Further, in an embodiment, each of the tray for plant 1902, the tray for micro green 2002, and the tray for mushroom 2102 may include a mist outlet (1906, 2006, and 2106). Further, the mist outlet (1906, 2006, and 2106) may be configured for allowing mist to pass from a bottom interior space 1706 of the bottom enclosure 1404 to the interior space 1420.

Further, in an embodiment, the bottom enclosure 1404 may include a venting hole 2202 leading into the bottom interior space 1706. Further, the venting hole 2202 may provide fluid communication between the bottom interior space 1706 and an external space surrounding the apparatus 1400. Further, the venting hole 2202 may be a hole for ventilation to the bottom enclosure 1404. Further, in an embodiment, the plurality of sensors 1412 may include a camera 1604, a dual function temperature and humidity sensor 1708, and a capacitive water level sensor 2208. Further, the camera 1604 may be configured for capturing images of the plant. Further, the camera 1604 may be attached to the top inner surface 1602. Further, the field of view of the camera 1604 may encompass the interior space 1420. Further, the dual function temperature and humidity sensor 1708 may be configured for receiving an indication of a temperature and humidity associated with at least one of the interior space 1420 and bottom interior space 1706. Further, the dual function temperature and humidity sensor 1708 may be included in the bottom enclosure 1404. Further, the capacitive water level sensor 2208 may be configured for receiving an indication of the water level in the nutrition container 1416. Further, the capacitive water level sensor 2208 may be included in the bottom enclosure 1404. Further, in an embodiment, the plurality of environmental actuators 1414 may include at least one LED 1606, an LED diffuser 1608, a first piezo pump 1710, a second piezo pump 1712, a heating pad 2204, a heat sink 2206, a cooling fan 2208, and a fan 1610. Further, the at least one LED 1606 may be configured for emitting radiation for facilitating growth of the plant. Further, the at least one LED 1606 may be included in the top enclosure 1402. Further, the LED diffuser 1608 may be optically coupled to the at least one LED 1606. Further, the LED diffuser 1608 may be a diffuser sheet. Further, the LED diffuser 1608 may be configured for evenly distributing the radiation emitted by the at least one LED 1606. Further, the LED diffuser 1608 may be included in the top enclosure 1402. Further, the first piezo pump 1710 may be configured for generating mist to facilitate irrigation of the plant. Further, the first piezo pump 1710 may be included in the bottom enclosure 1404. Further, the second piezo pump 1712 may be configured for generating mist to facilitate control of the temperature and the humidity. Further, the heating pad 2204 may be configured for increasing the temperature. Further, the heating pad 2204 may be included in the bottom enclosure 1404. Further, the heat sink 2206 may be configured for absorbing and transferring heat. Further, the heat sink 2206 may be included in the bottom enclosure 1404. Further, the cooling fan 2208 may be configured for generating an air flow for the heat transferred by the heat sink 2206. Further, the cooling fan 2208 may be included in the bottom enclosure 1404. Further, the fan 1610 may be configured for generating an air flow for the mist generated by the first piezo pump 1710. Further, the fan 1610 may be mounted on the top inner surface 1602. Further, the fan 1610 may be included in the top enclosure 1402.

Further, in some embodiments, the processing device 1418 may be configured for analyzing the plurality of sensor data using a machine learning model. Further, the machine learning model may be trained for determining levels of environmental variables required by the plant using sensor data.

Further, in some embodiments, the tray 1410 may include a water inlet 2302. Further, the water inlet 2302 may be configured for receiving water and nutrition into the nutrition container 1416.

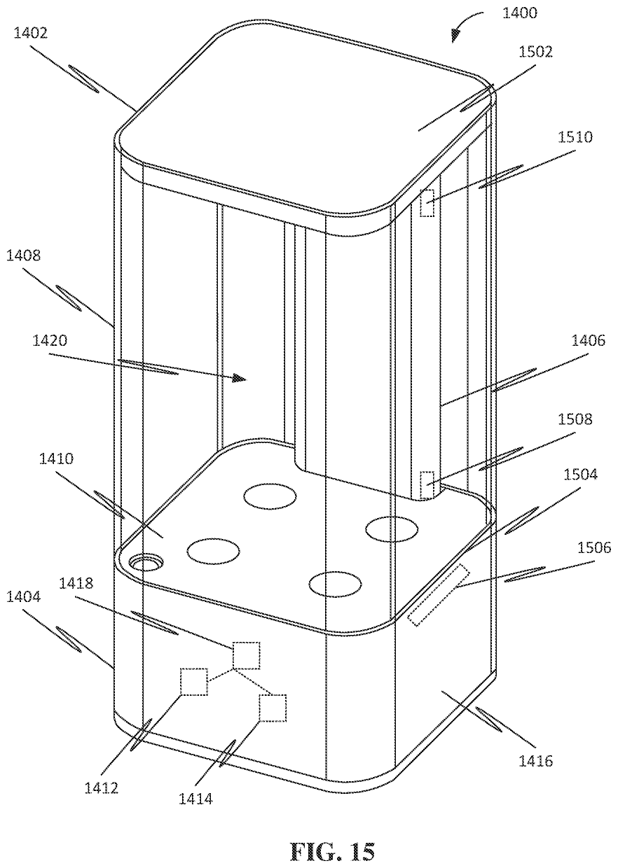

FIG. 15 is a top right side perspective view of the apparatus 1400 for facilitating cultivation of plants, in accordance with some embodiments.

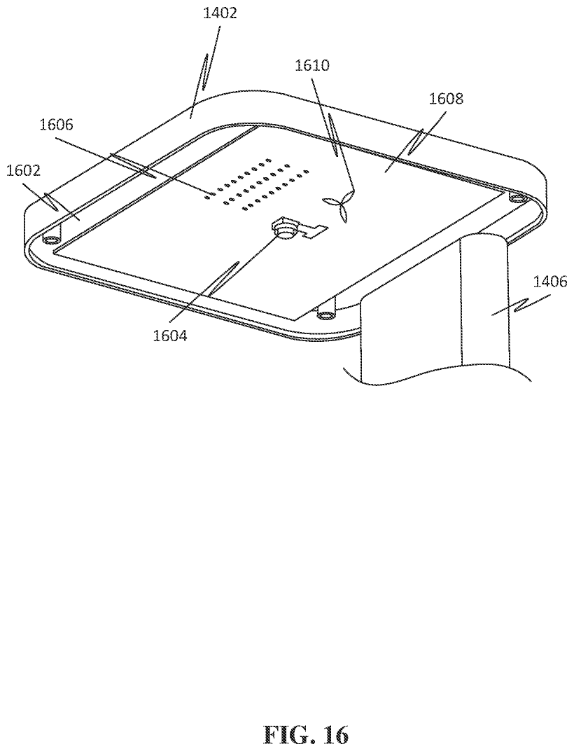

FIG. 16 is a bottom perspective view of the top enclosure of the apparatus 1400, in accordance with some embodiments.

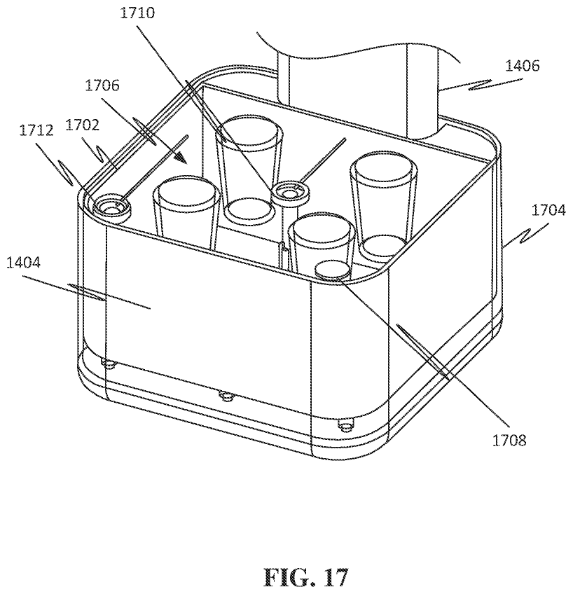

FIG. 17 is a top perspective view of the bottom enclosure 1404 of the apparatus 1400 without tray 1410, in accordance with some embodiments.

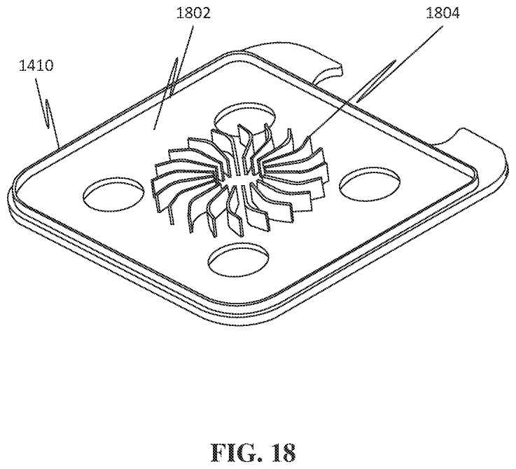

FIG. 18 is a bottom perspective view of the tray 1410 of the apparatus 1400, in accordance with some embodiments.

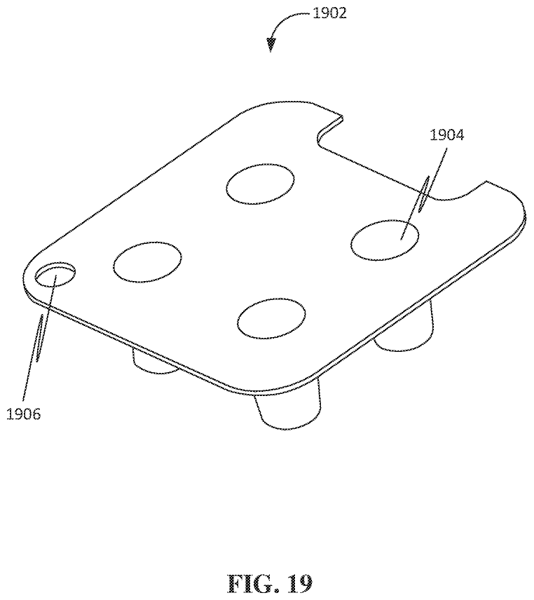

FIG. 19 is a top right perspective view of the tray for plant 1902 of the apparatus 1400, in accordance with some embodiments.

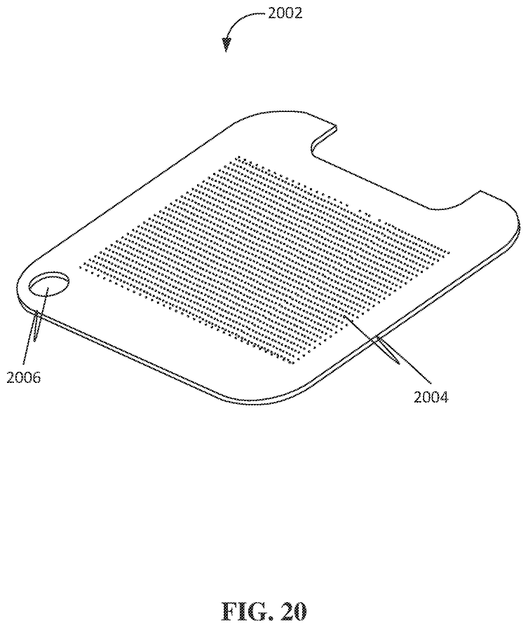

FIG. 20 is a top right perspective view of the tray for micro green 2002 of the apparatus 1400, in accordance with some embodiments.

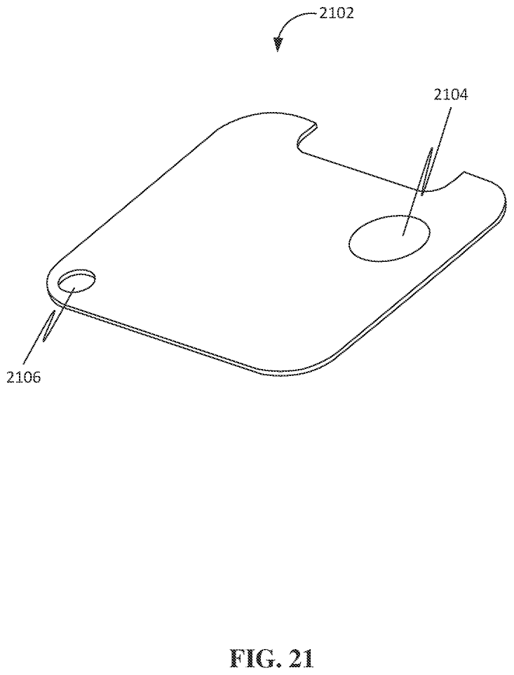

FIG. 21 is a top right perspective view of the tray for mushroom 2102 of the apparatus 1400, in accordance with some embodiments.

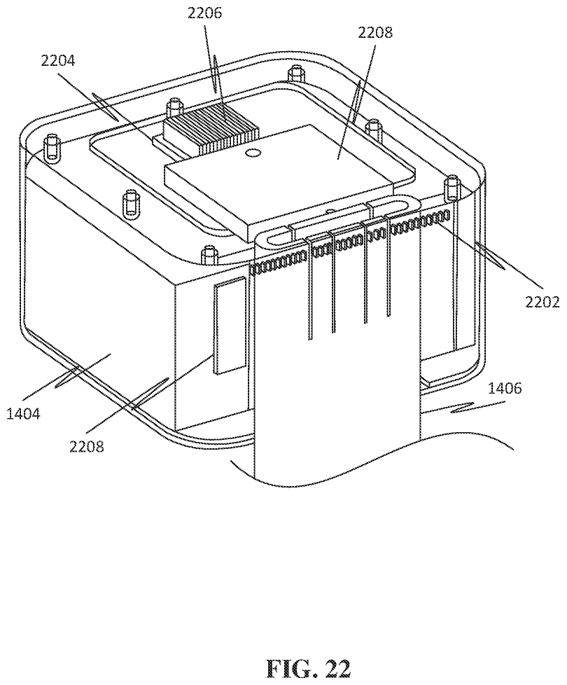

FIG. 22 is the bottom left side perspective view of the bottom enclosure 1404 of apparatus 1400 without the bottom outer surface 1704, in accordance with some embodiments.

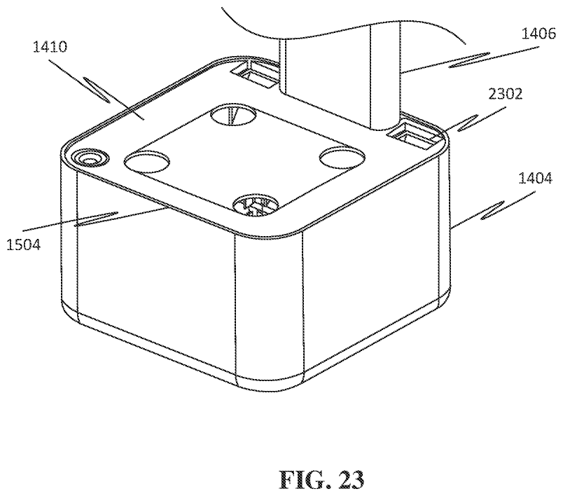

FIG. 23 is the top left side perspective view of the bottom enclosure 1404 of apparatus 1400, in accordance with some embodiments.

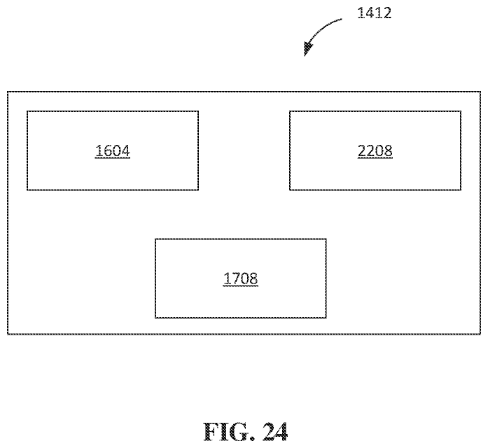

FIG. 24 is a block diagram of the plurality of sensors 1412 of the apparatus 1400, in accordance with some embodiments.

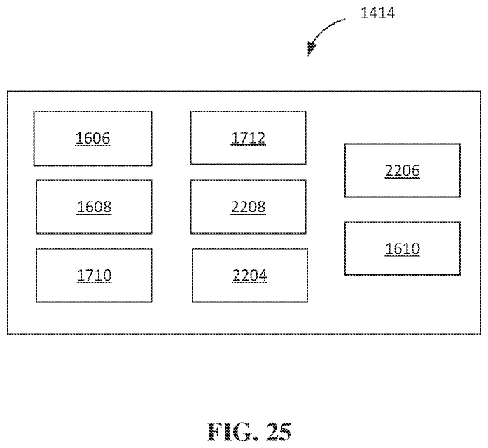

FIG. 25 is a block diagram of the plurality of environmental actuators 1414 of the apparatus 1400, in accordance with some embodiments.

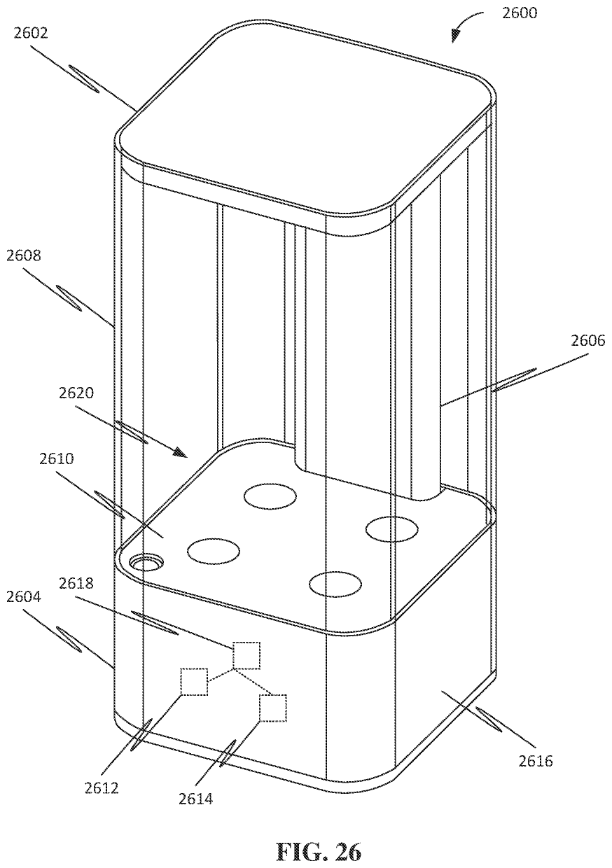

FIG. 26 is a top right side perspective view of an apparatus 2600 for facilitating cultivation of plants, in accordance with some embodiments. Accordingly, the apparatus 2600 may include a top enclosure 2602, a bottom enclosure 2604, a vertical column 2606, a cover 2608, a tray 2610, a plurality of sensors 2612, a plurality of environmental actuators 2614, a nutrition container 2616, and a processing device 2618.

Further, the top enclosure 2602 may be configured for housing at least one first component.

Further, the bottom enclosure 2604 may be configured for housing at least one second component.

Further, the vertical column 2606 may be interspersed between the top enclosure 2602 and the bottom enclosure 2604 may be forming an interior space 2620 therebetween. Further, the vertical column 2606 may include a plurality of fasteners disposed on either end of the vertical column 2606. Further, the plurality of fasteners may be configured for detachably coupling the vertical column 2606 to each of the top enclosure 2602 and the bottom enclosure 2604.

Further, the cover 2608 may be interspersed between the top enclosure 2602 and the bottom enclosure 2604. Further, the cover 2608 may be configured for enclosing the interior space 2620. Further, the cover 2608 may be configured for allowing light to enter from a surrounding of the apparatus 2600 into the interior space 2620.

Further, the tray 2610 may be configured for holding a plant.

Further, the plurality of sensors 2612 may be configured for generating a plurality of sensor data representing a plurality of variables associated with the interior space 2620.

Further, the plurality of environmental actuators 2614 may be configured for controlling a plurality of environmental variables associated with the interior space 2620.

Further, the nutrition container 2616 may be configured for containing a nutritional medium.

Further, the processing device 2618 may be communicatively coupled to the plurality of sensors 2612 and the plurality of environmental actuators 2614. Further, the processing device 2618 may be configured for controlling the plurality of environmental actuators 2614 based on the plurality of sensor data.

Further, in some embodiments, the top enclosure 2602 may include a top outer surface and a top inner surface. Further, the top outer surface may be opposed to the top inner surface. Further, the bottom enclosure 2604 may include a bottom inner surface and a bottom outer surface such that the bottom inner surface opposes the top inner surface. Further, the cover 2608 may be removably attached to a bottom periphery of the bottom inner surface using a friction clasp.

Further, in an embodiment, the tray 2610 may include a tray top surface and a tray bottom surface. Further, the tray bottom surface may include fins. Further, the fins may be configured for guiding a flow of mist. Further, the tray 2610 may include a tray for plant, a tray for micro green, and a tray for mushroom. Further, the tray for plant may include at least one plant holder. Further, the at least one plant holder may be configured for holding a plant. Further, the tray for micro green may include a plurality of mini holes. Further, each of the plurality of mini holes may be configured for holding a micro green. Further, the tray for mushroom may include a holder. Further, the holder may be configured for holding a mushroom. Further, in an embodiment, each of the tray for plant, the tray for micro green, and the tray for mushroom may include a mist outlet. Further, the mist outlet may be configured for allowing mist to pass from a bottom interior space to the interior space.

Further, in an embodiment, the bottom enclosure 2604 may include a venting hole leading into the bottom interior space. Further, the venting hole may provide fluid communication between the bottom interior space and an external space surrounding the apparatus 2600. Further, in an embodiment, the plurality of sensors 2612 may include a camera, a dual function temperature and humidity sensor, and a capacitive water level sensor. Further, the camera may be configured for capturing images of the plant. Further, the camera may be attached to the top inner surface. Further, the field of view of the camera encompasses the interior space. Further, the dual function temperature and humidity sensor may be configured for receiving an indication of a temperature and a humidity associated with at least one of the interior space and the bottom interior space. Further, the dual function temperature and humidity sensor may be included in the bottom enclosure 2604. Further, the capacitive water level sensor may be configured for receiving an indication of water level in the nutrition container 2616. Further, the capacitive water sensor may be included in the bottom enclosure 2604. Further, in an embodiment, the plurality of environmental actuators 2614 may include at least one LED, an LED diffuser, a first piezo pump, a second piezo pump, a heating pad, a heat sink, a cooling fan, and a fan. Further, the at least one LED may be configured for emitting radiation for facilitating growth of the plant. Further, the at least one LED may be included in the top enclosure. Further, the LED diffuser may be optically coupled to the at least one LED. Further, the LED diffuser may be configured for evenly distributing the radiation emitted by the at least one LED. Further, the LED diffuser may be included in the top enclosure 2602. Further, the first piezo pump may be configured for generating mist to facilitate irrigation of the plant. Further, the first piezo pump may be included in the bottom enclosure 2604. Further, the second piezo pump may be configured for generating mist to facilitate control of the temperature and the humidity. Further, the heating pad may be configured for increasing the temperature. Further, the heating pad may be included in the bottom enclosure 2604. Further, the heat sink may be configured for absorbing and transferring heat. Further, the heat sink may be included in the bottom enclosure 2604. Further, the cooling fan may be configured for generating an air flow for the heat transferred by the heat sink. Further, the cooling fan may be included in the bottom enclosure 2604. Further, the fan may be configured for generating an air flow for the mist generated by the first piezo pump. Further, the fan may be mounted on the top inner surface. Further, the fan may be included in the top enclosure 2602.

Further, in some embodiments, the processing device 2618 may be configured for analyzing the plurality of sensor data using a machine learning model.

Further, in some embodiments, the tray 2610 may include a water inlet. Further, the water inlet may be configured for receiving water and nutrition into the nutrition container 2616.

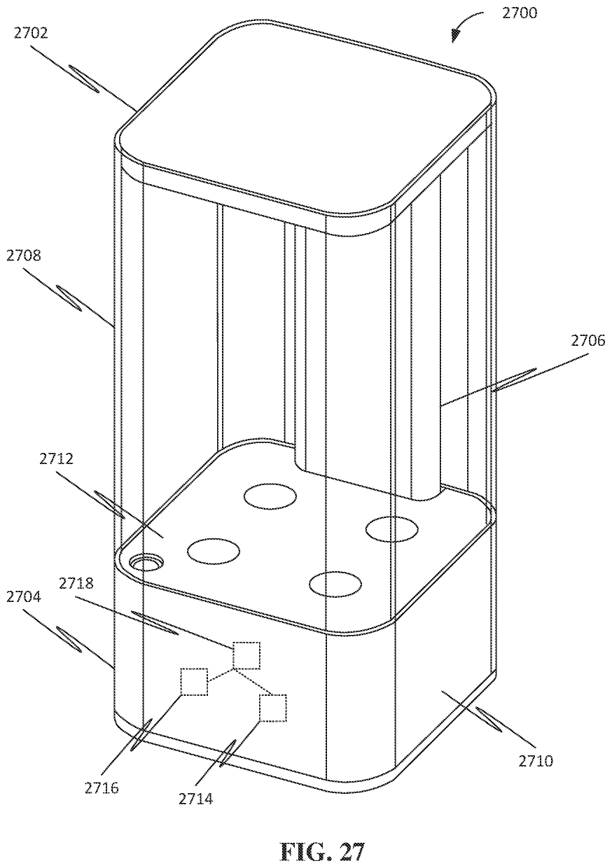

FIG. 27 is a top right side perspective view of an apparatus 2700 for facilitating cultivation of plants. Accordingly, the apparatus 2700 may include a top enclosure 2702, a bottom enclosure 2704, a vertical column 2706, a cover 2708, a nutrition container 2710, a tray 2712, a plurality of sensors 2714, a plurality of environmental actuators 2716, and a processing device 2718.

Further, the top enclosure 2702 may be configured for housing at least one first component. Further, the top enclosure 2702 may include a top outer surface and a top inner surface. Further, the top outer surface may be opposed to the top inner surface.

Further, the bottom enclosure 2704 may be configured for housing at least one second component. Further, the bottom enclosure 2704 may include a venting hole leading into a bottom interior space. Further, the venting hole may provide fluid communication between the bottom interior space and an external space surrounding the apparatus 2700. Further, the bottom enclosure 2704 may include a bottom inner surface and a bottom outer surface such that the bottom inner surface opposes the top inner surface.

Further, the vertical column 2706 may be interspersed between the top enclosure 2702 and the bottom enclosure 2704 forming an interior space therebetween. Further, the vertical column 2706 may include a plurality of fasteners disposed on either end of the vertical column 2706. Further, the plurality of fasteners may be configured for detachably coupling the vertical column 2706 to each of the top enclosure 2702 and the bottom enclosure 2704.

Further, the cover 2708 may be interspersed between the top enclosure 2702 and the bottom enclosure 2704. Further, the cover 2708 may be configured for enclosing the interior space. Further, the cover 2708 may be configured for allowing light to enter from a surrounding of the apparatus 2700 into the interior space. Further, the cover 2708 may be removably attached to a bottom periphery of the bottom inner surface using a friction clasp.

Further, the nutrition container 2710 may be configured for containing a nutritional medium. Further, the tray 2712 may be configured for holding a plant.

Further, the tray 2712 may include a water inlet. Further, the water inlet may be configured for receiving water and nutrition into the nutrition container 2710. Further, the tray 2712 may include a tray top surface and a tray bottom surface. Further, the tray bottom surface may include fins. Further, the fins may be configured for guiding a flow of mist. Further, the tray 2712 may include a tray for plant, a tray for micro green, and a tray for mushroom. Further, the tray for plant may include at least one plant holder. Further, the at least one plant holder may be configured for holding a plant. Further, the tray for micro green may include a plurality of mini holes. Further, each of the plurality of mini holes may be configured for holding a micro green. Further, the tray for mushroom may include a holder. Further, the holder may be configured for holding a mushroom. Further, each of the tray for plant, the tray for micro green, and the tray for mushroom may include a mist outlet. Further, the mist outlet may be configured for allowing mist to pass from the bottom interior space to the interior space.

Further, the plurality of sensors 2714 may be configured for generating a plurality of sensor data representing a plurality of variables associated with the interior space. Further, the plurality of sensors 2714 may include a camera, a dual function temperature and humidity sensor, and a capacitive water level sensor. Further, the camera may be configured for capturing images of the plant. Further, the camera may be attached to the top inner surface. Further, the field of view of the camera may encompass the interior space. Further, the dual function temperature and a humidity sensor may be configured for receiving an indication of a temperature and a humidity associated with at least one of the interior space and the bottom interior space. Further, the dual function temperature and humidity sensor may be included in the bottom enclosure. Further, the capacitive water level sensor may be configured for receiving an indication of water level in the nutrition container 2710. Further, the capacitive water sensor may be included in the bottom enclosure 2704.

Further, the plurality of environmental actuators 2716 may be configured for controlling a plurality of environmental variables associated with the interior space. Further, the plurality of environmental actuators 2716 may include at least one LED, an LED diffuser, a first piezo pump, a second piezo pump, a heating pad, a heat sink, a cooling fan, and a fan. Further, the at least one LED may be configured for emitting radiation for facilitating growth of the plant. Further, the at least one LED may be included in the top enclosure 2702. Further, the LED diffuser may be optically coupled to the at least one LED. Further, the LED diffuser may be configured for evenly distributing the radiation emitted by the at least one LED. Further, the LED diffuser may be included in the top enclosure 2702. Further, the first piezo pump may be configured for generating mist to facilitate irrigation of the plant. Further, the first piezo pump may be included in the bottom enclosure 2704. Further, the second piezo pump may be configured for generating mist to facilitate control of the temperature and the humidity. Further, the heating pad may be configured for increasing the temperature. Further, the heating pad may be included in the bottom enclosure 2704. Further, the heat sink may be configured for absorbing and transferring heat. Further, the heat sink may be included in the bottom enclosure 2704. Further, the cooling fan may be configured for generating an air flow for the heat transferred by the heat sink. Further, the cooling fan may be included in the bottom enclosure 2704. Further, the fan may be configured for generating an air flow for the mist generated by the first piezo pump. Further, the fan may be mounted on the top inner surface. Further, the fan may be included in the top enclosure 2702.

Further, the processing device 2718 may be communicatively coupled to the plurality of sensors 2714 and the plurality of environmental actuators 2716. Further, the processing device 2718 may be configured for controlling the plurality of environmental actuators 2716 based on the plurality of sensor data. Further, the processing device 2718 may be configured for analyzing the plurality of sensor data using a machine learning model.

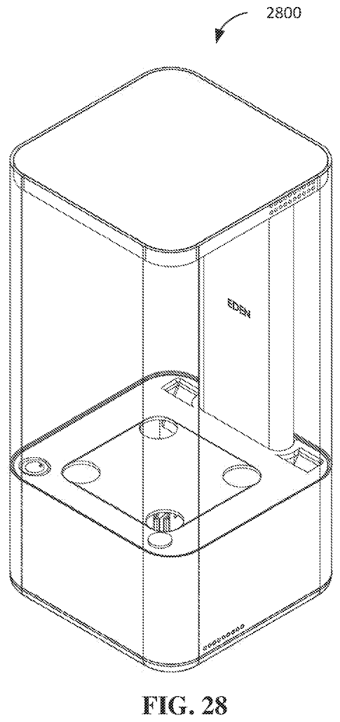

FIG. 28 is a front right side perspective view of a karpos cultivation AI automation planting device 2800 for facilitating cultivation of plants, in accordance with some embodiments.

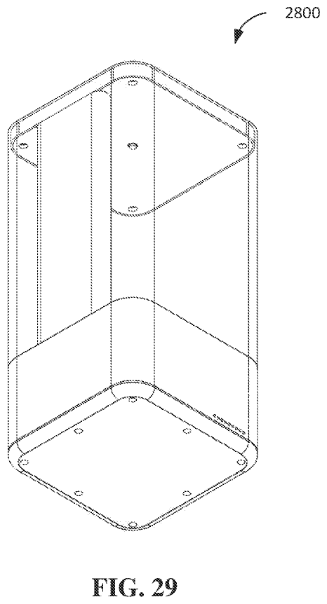

FIG. 29 is a bottom rear right side perspective view of the karpos cultivation AI automation planting device 2800 for facilitating cultivation of plants, in accordance with some embodiments.

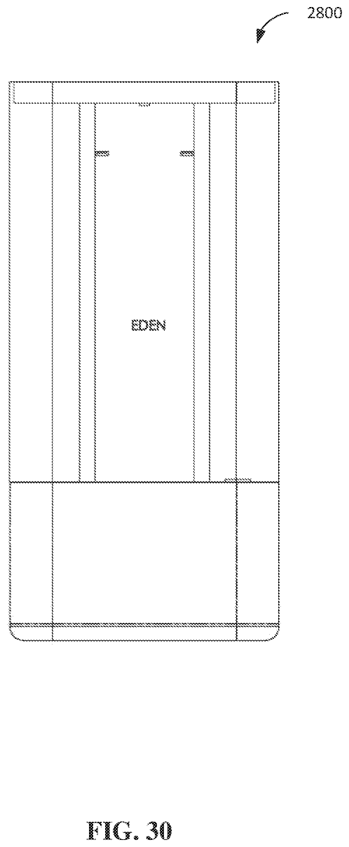

FIG. 30 is a front view of the karpos cultivation AI automation planting device 2800 for facilitating cultivation of plants, in accordance with some embodiments.

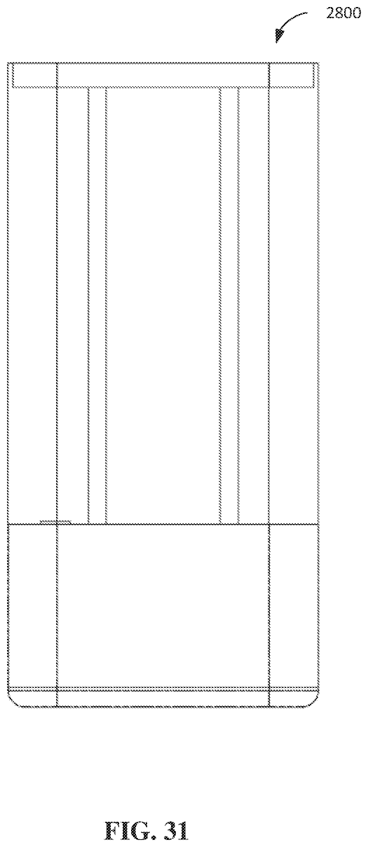

FIG. 31 is a rear view of the karpos cultivation AI automation planting device 2800 for facilitating cultivation of plants, in accordance with some embodiments.

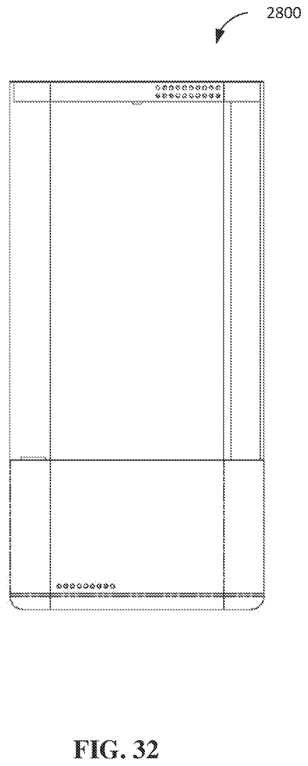

FIG. 32 is a right side view of the karpos cultivation AI automation planting device 2800 for facilitating cultivation of plants, in accordance with some embodiments.

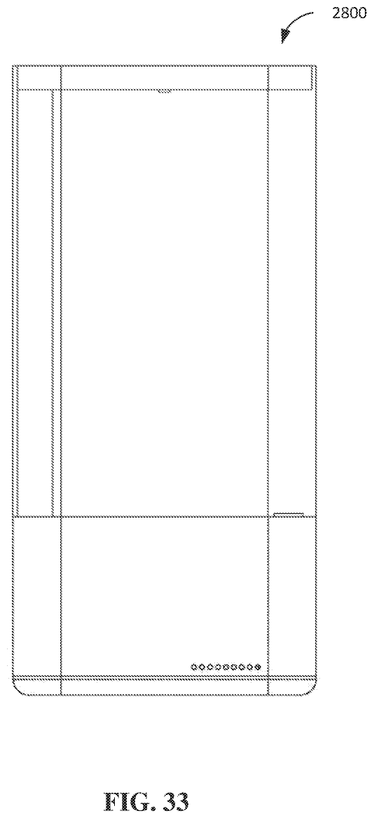

FIG. 33 is a left side view of the karpos cultivation AI automation planting device 2800 for facilitating cultivation of plants, in accordance with some embodiments.

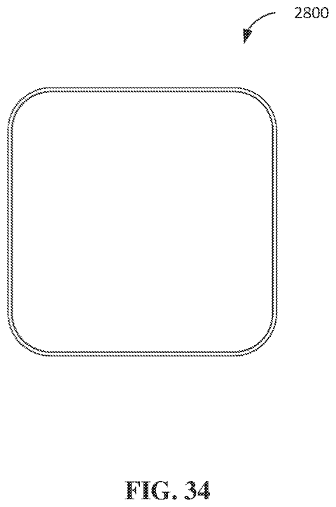

FIG. 34 is a top view of the karpos cultivation AI automation planting device 2800 for facilitating cultivation of plants, in accordance with some embodiments.

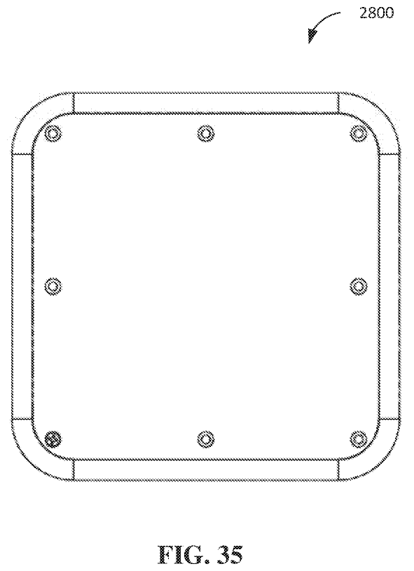

FIG. 35 is a bottom view of the karpos cultivation AI automation planting device 2800 for facilitating cultivation of plants, in accordance with some embodiments.

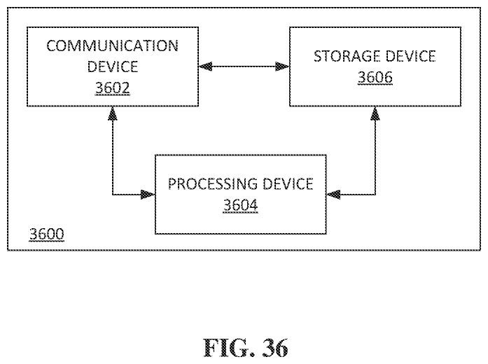

FIG. 36 is a block diagram of a system 3600 for facilitating cultivation of plants using a karpos cultivation AI automation planting device, in accordance with some embodiments. Accordingly, the system 3600 may include a communication device 3602 configured for receiving plant data from at least one input device. Further, the at least one input device may include a karpos cultivation AI automation planting device (such as the device [001]). Further, the karpos cultivation AI automation planting device may include a plurality of sensors. Further, the plurality of sensors may include a light sensor, a temperature sensor, a pressure sensor, an image sensor, an audio sensor, an infrared sensor, etc. Further, the plant data may be associated with plants that may be grown in the karpos cultivation AI automation plantation device. Further, the plant data may indicate a growth status of the plants. Further, the communication device 3602 may be configured for transmitting an action alert to the karpos cultivation AI automation planting device. Further, the communication device 3602 may be configured for transmitting the action alert, the plant data, and a plant growth status to at least one user device. Further, the at least one user device may be associated with the at least one user that may include an individual, an institution, and an organization that may want to cultivate plants using the karpos cultivation AI automation planting device. Further, the at least one user device may include a smartphone, a tablet, a laptop, a mobile, a desktop, and so on.

Further, the system 3600 may include a processing device 3604 configured for analyzing the plant data using a machine learning model. Further, the machine learning model may be based on a machine learning algorithm. Further, the processing device 3604 may be configured for determining the plant growth status based on the analyzing. Further, the processing device 3604 may be configured for processing the plant growth status. Further, the processing device 3604 may be configured for generating the action alert based on the processing. Further, the action alert may include an actuation notification that may facilitate actuating the karpos cultivation AI automation planting device for performing at least one plantation action such as controlling temperature, light, moisture, etc.

Further, the system 3600 may include a storage device 3606 configured for storing the action alert, the plant data, and the plant growth status.

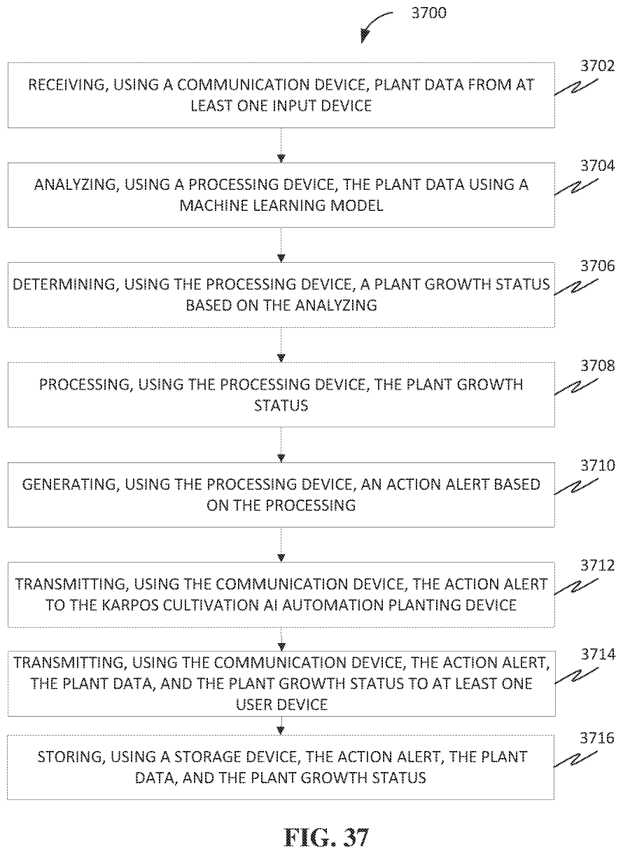

FIG. 37 is a flow chart of a method 3700 for facilitating cultivation of plants using a karpos cultivation AI automation planting device, in accordance with some embodiments. Accordingly, at 3702, the method 3700 may include receiving, using a communication device, plant data from at least one input device. Further, the at least one input device may include a karpos cultivation AI automation planting device (such as the device [001]). Further, the karpos cultivation AI automation planting device may include a plurality of sensors. Further, the plurality of sensors may include a light sensor, a temperature sensor, a pressure sensor, an image sensor, an audio sensor, an infrared sensor, etc. Further, the plant data may be associated with plants that may be grown in the karpos cultivation AI automation plantation device. Further, the plant data may indicate a growth status of the plants.

Further, at 3704, the method 3700 may include analyzing, using a processing device, the plant data using a machine learning model. Further, the machine learning model may be based on a machine learning algorithm.

Further, at 3706, the method 3700 may include determining, using the processing device, a plant growth status based on the analyzing.

Further, at 3708, the method 3700 may include processing, using the processing device, the plant growth status.

Further, at 3710, the method 3700 may include generating, using the processing device, an action alert based on the processing. Further, the action alert may include an actuation notification that may facilitate actuating the karpos cultivation AI automation planting device for performing at least one plantation action such as controlling temperature, light, moisture, etc.

Further, at 3712, the method 3700 may include transmitting, using the communication device, the action alert to the karpos cultivation AI automation planting device.

Further, at 3714, the method 3700 may include transmitting, using the communication device, the action alert, the plant data, and the plant growth status to at least one user device. Further, the at least one user device may be associated with the at least one user that may include an individual, an institution, and an organization that may want to cultivate plants using the karpos cultivation AI automation planting device. Further, the at least one user device may include a smartphone, a tablet, a laptop, a mobile, a desktop, and so on.

Further, at 3716, the method 3700 may include storing, using a storage device, the action alert, the plant data, and the plant growth status.

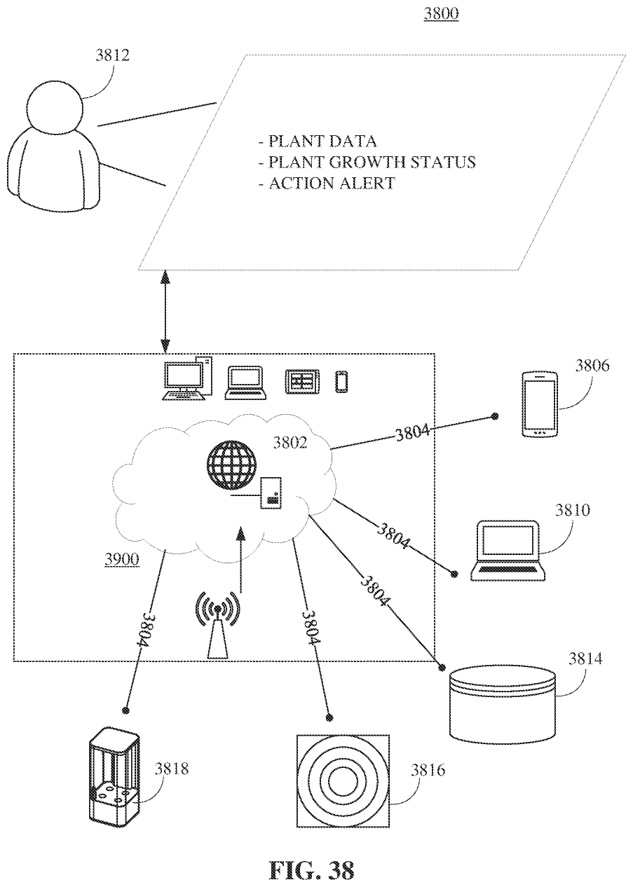

FIG. 38 is an illustration of an online platform 3800 consistent with various embodiments of the present disclosure. By way of non-limiting example, the online platform 3800 to facilitate cultivation of plants may be hosted on a centralized server 3802, such as, for example, a cloud computing service. The centralized server 3802 may communicate with other network entities, such as, for example, a mobile device 3806 (such as a smartphone, a laptop, a tablet computer etc.), other electronic devices 3810 (such as desktop computers, server computers etc.), databases 3814, sensors 3816, and an apparatus 3818 (the karpos cultivation AI automation planting device [001], the apparatus 1400, the apparatus 2600, the apparatus 2700, etc.) over a communication network 3804, such as, but not limited to, the Internet. Further, users of the online platform 3800 may include relevant parties such as, but not limited to, end-users, administrators, service providers, service consumers and so on. Accordingly, in some instances, electronic devices operated by the one or more relevant parties may be in communication with the platform.

A user 3812, such as the one or more relevant parties, may access online platform 3800 through a web based software application or browser. The web based software application may be embodied as, for example, but not be limited to, a website, a web application, a desktop application, and a mobile application compatible with a computing device 3900.

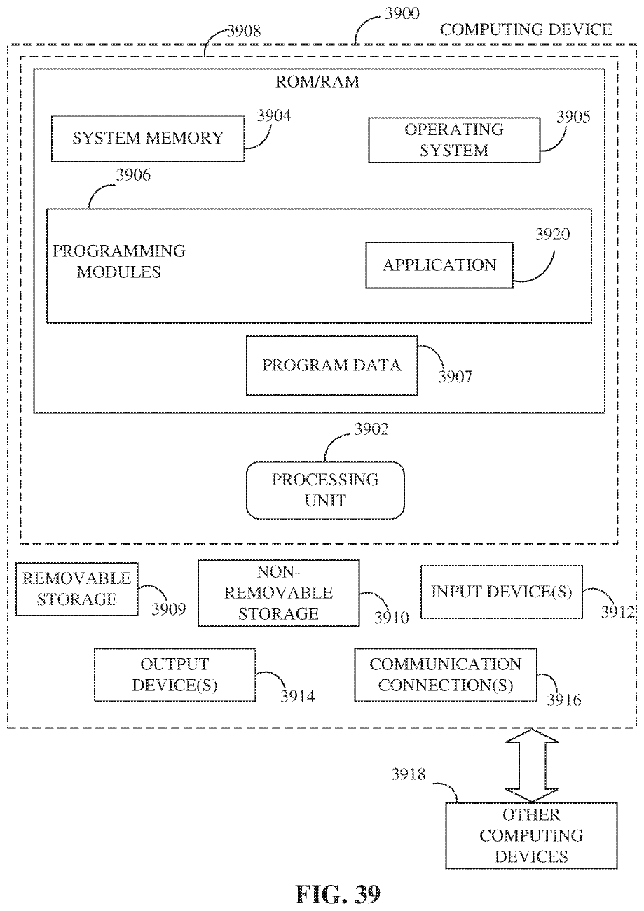

With reference to FIG. 39, a system consistent with an embodiment of the disclosure may include a computing device or cloud service, such as computing device 3900. In a basic configuration, computing device 3900 may include at least one processing unit 3902 and a system memory 3904. Depending on the configuration and type of computing device, system memory 3904 may comprise, but is not limited to, volatile (e.g. random-access memory (RAM)), non-volatile (e.g. read-only memory (ROM)), flash memory, or any combination. System memory 3904 may include operating system 3905, one or more programming modules 3906, and may include a program data 3907. Operating system 3905, for example, may be suitable for controlling computing device 3900's operation. In one embodiment, programming modules 3906 may include image-processing module, machine learning module. Furthermore, embodiments of the disclosure may be practiced in conjunction with a graphics library, other operating systems, or any other application program and is not limited to any particular application or system. This basic configuration is illustrated in FIG. 39 by those components within a dashed line 3908.

Computing device 3900 may have additional features or functionality. For example, computing device 3900 may also include additional data storage devices (removable and/or non-removable) such as, for example, magnetic disks, optical disks, or tape. Such additional storage is illustrated in FIG. 39 by a removable storage 3909 and a non-removable storage 3910. Computer storage media may include volatile and non-volatile, removable and non-removable media implemented in any method or technology for storage of information, such as computer-readable instructions, data structures, program modules, or other data. System memory 3904, removable storage 3909, and non-removable storage 3910 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 3900. Any such computer storage media may be part of device 3900. Computing device 3900 may also have input device(s) 3912 such as a keyboard, a mouse, a pen, a sound input device, a touch input device, a location sensor, a camera, a biometric sensor, etc. Output device(s) 3914 such as a display, speakers, a printer, etc. may also be included. The aforementioned devices are examples and others may be used.

Computing device 3900 may also contain a communication connection 3916 that may allow device 3900 to communicate with other computing devices 3918, such as over a network in a distributed computing environment, for example, an intranet or the Internet. Communication connection 3916 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 3904, including operating system 3905. While executing on processing unit 3902, programming modules 3906 (e.g., application 3920 such as a media player) may perform processes including, for example, one or more stages of methods, algorithms, systems, applications, servers, databases as described above. The aforementioned process is an example, and processing unit 3902 may perform other processes. Other programming modules that may be used in accordance with embodiments of the present disclosure may include machine learning applications.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

Although the present disclosure has been explained in relation to its preferred embodiment, it is to be understood that many other possible modifications and variations can be made without departing from the spirit and scope of the disclosure.

What is claimed is:

1. An apparatus for facilitating cultivation of plants, wherein the apparatus comprises:
a top enclosure configured for housing at least one first component;
a bottom enclosure configured for housing at least one second component;
a vertical column interspersed between the top enclosure and the bottom enclosure forming an interior space therebetween;
a cover interspersed between the top enclosure and the bottom enclosure, wherein the cover is configured for enclosing the interior space, wherein the cover is further configured for allowing light to enter from a surrounding of the apparatus into the interior space;
a tray configured for holding a plant;
a plurality of sensors configured for generating a plurality of sensor data representing a plurality of variables associated with the interior space;
a plurality of environmental actuators configured for controlling a plurality of environmental variables associated with the interior space;
a nutrition container configured for containing a nutritional medium; and
a processing device communicatively coupled to the plurality of sensors and the plurality of environmental actuators, wherein the processing device is configured for controlling the plurality of environmental actuators based on the plurality of sensor data.

2. The apparatus of claim 1, wherein the vertical column comprises a plurality of fasteners disposed on either end of the vertical column, wherein the plurality of fasteners is configured for detachably coupling the vertical column to each of the top enclosure and the bottom enclosure.

3. The apparatus of claim 1, wherein the top enclosure comprises a top outer surface and a top inner surface, wherein the top outer surface is opposed to the top inner surface, wherein the bottom enclosure comprises a bottom inner surface and a bottom outer surface such that the bottom inner surface opposes the top inner surface, wherein the cover is removably attached to a bottom periphery of the bottom inner surface using a friction clasp.

4. The apparatus of claim 1, wherein the processing device is configured for analyzing the plurality of sensor data using a machine learning model.

5. The apparatus of claim 1, wherein the tray comprises a water inlet configured for receiving water and nutrition into the nutrition container.

6. The apparatus of claim 3, wherein the tray comprises a tray top surface and a tray bottom surface, wherein the tray bottom surface comprises fins configured for guiding a flow of mist, wherein the tray further comprises:
a tray for plant comprising at least one plant holder configured for holding a plant;
a tray for micro green comprising a plurality of mini holes configured for holding a micro green; and
a tray for mushroom comprising a holder configured for holding a mushroom.

7. The apparatus of claim 6, wherein each of the tray for plant, the tray for micro green, and the tray for mushroom comprise a mist outlet configured for allowing mist to pass from a bottom interior space to the interior space.

8. The apparatus of claim 3, wherein the bottom enclosure comprises a venting hole leading into the bottom interior space, wherein the venting hole provides fluid communication between the bottom interior space and an external space surrounding the apparatus.

9. The apparatus of claim 8, wherein the plurality of sensors comprises:
a camera configured for capturing images of the plant, wherein the camera is attached to the top inner surface, wherein the field of view of the camera encompasses the interior space;
a dual function temperature and humidity sensor configured for receiving an indication of a temperature and a humidity associated with at least one of the interior space and the bottom interior space, wherein the dual function temperature and humidity sensor is comprised in the bottom enclosure; and
a capacitive water level sensor configured for receiving an indication of water level in the nutrition container, wherein the capacitive water sensor is comprised in the bottom enclosure.

10. The apparatus of claim 8, wherein the plurality of environmental actuators comprises:
at least one LED configured for emitting radiation for facilitating growth of the plant, wherein the at least one LED is comprised in the top enclosure;
an LED diffuser optically coupled to the at least one LED, wherein the LED diffuser is configured for evenly distributing the radiation emitted by the at least one LED, wherein the LED diffuser is comprised in the top enclosure;
a first piezo pump configured for generating mist to facilitate irrigation of the plant, wherein the first piezo pump is comprised in the bottom enclosure;
a second piezo pump configured for generating mist to facilitate control of the temperature and the humidity;
a heating pad configured for increasing the temperature, wherein the heating pad is comprised in the bottom enclosure;
a heat sink configured for absorbing and transferring heat, wherein the heat sink is comprised in the bottom enclosure;
a cooling fan configured for generating an air flow for the heat transferred by the heat sink, wherein the cooling fan is comprised in the bottom enclosure; and
a fan configured for generating an air flow for the mist generated by the first piezo pump, wherein the fan is mounted on the top inner surface, wherein the fan is comprised in the top enclosure.

11. An apparatus for facilitating cultivation of plants, wherein the apparatus comprises:
a top enclosure configured for housing at least one first component;
a bottom enclosure configured for housing at least one second component;
a vertical column interspersed between the top enclosure and the bottom enclosure forming an interior space therebetween, wherein the vertical column comprises a plurality of fasteners disposed on either end of the vertical column, wherein the plurality of fasteners is configured for detachably coupling the vertical column to each of the top enclosure and the bottom enclosure;
a cover interspersed between the top enclosure and the bottom enclosure, wherein the cover is configured for enclosing the interior space, wherein the cover is further configured for allowing light to enter from a surrounding of the apparatus into the interior space;
a tray configured for holding a plant;
a plurality of sensors configured for generating a plurality of sensor data representing a plurality of variables associated with the interior space;
a plurality of environmental actuators configured for controlling a plurality of environmental variables associated with the interior space;
a nutrition container configured for containing a nutritional medium; and
a processing device communicatively coupled to the plurality of sensors and the plurality of environmental actuators, wherein the processing device is configured for controlling the plurality of environmental actuators based on the plurality of sensor data.

12. The apparatus of claim 11, wherein the top enclosure comprises a top outer surface and a top inner surface, wherein the top outer surface is opposed to the top inner surface, wherein the bottom enclosure comprises a bottom inner surface and a bottom outer surface such that the bottom inner surface opposes the top inner surface, wherein the cover is removably attached to a bottom periphery of the bottom inner surface using a friction clasp.

13. The apparatus of claim 11, wherein the processing device is configured for analyzing the plurality of sensor data using a machine learning model.

14. The apparatus of claim 11, wherein the tray comprises a water inlet configured for receiving water and nutrition into the nutrition container.

15. The apparatus of claim 12, wherein the tray comprises a tray top surface and a tray bottom surface, wherein the tray bottom surface comprises fins configured for guiding a flow of mist, wherein the tray comprises:
a tray for plant comprising at least one plant holder configured for holding a plant;
a tray for micro green comprising a plurality of mini holes configured for holding a micro green; and
a tray for mushroom comprising a holder configured for holding a mushroom.

16. The apparatus of claim 15, wherein each of the tray for plant, the tray for micro green, and the tray for mushroom comprise a mist outlet configured for allowing mist to pass from the bottom interior space to the interior space.

17. The apparatus of claim 12, wherein the bottom enclosure comprises a venting hole leading into a bottom interior space, wherein the venting hole provides fluid communication between the bottom interior space and an external space surrounding the apparatus.

18. The apparatus of claim 17, wherein the plurality of sensors comprises:
a camera configured for capturing images of the plant, wherein the camera is attached to the top inner surface, wherein the field of view of the camera encompasses the interior space;
a dual function temperature and humidity sensor configured for receiving an indication of a temperature and a humidity associated with at least one of the interior space and the bottom interior space, wherein the dual function temperature and humidity sensor is comprised in the bottom enclosure; and
a capacitive water level sensor configured for receiving an indication of water level in the nutrition container, wherein the capacitive water sensor is comprised in the bottom enclosure.

19. The apparatus of claim 17, wherein the plurality of environmental actuators comprises:
at least one LED configured for emitting radiation for facilitating growth of the plant, wherein the at least one LED is comprised in the top enclosure;
an LED diffuser optically coupled to the at least one LED, wherein the LED diffuser is configured for even distribution of the radiation emitted by the at least one LED, wherein the LED diffuser is comprised in the top enclosure;
a first piezo pump configured for generating mist to facilitate irrigation of the plant, wherein the first piezo pump is comprised in the bottom enclosure;
a second piezo pump configured for generating mist to facilitate control of the temperature and the humidity;
a heating pad configured for increasing the temperature, wherein the heating pad is comprised in the bottom enclosure;
a heat sink configured for absorbing and transferring heat, wherein the heat sink is comprised in the bottom enclosure;
a cooling fan configured for generating an air flow for the heat transferred by the heat sink, wherein the cooling fan is comprised in the bottom enclosure; and
a fan configured for generating an air flow for the mist generated by the first piezo pump, wherein the fan is mounted on the top inner surface, wherein the fan is comprised in the top enclosure.

20. An apparatus for facilitating cultivation of plants, wherein the apparatus comprises:
a top enclosure configured for housing at least one first component, wherein the top enclosure comprises a top outer surface and a top inner surface, wherein the top outer surface is opposed to the top inner surface;
a bottom enclosure configured for housing at least one second component, wherein the bottom enclosure comprises a venting hole leading into a bottom interior space, wherein the venting hole provides fluid communication between the bottom interior space and an external space surrounding the apparatus, wherein the bottom enclosure comprises a bottom inner surface and a bottom outer surface such that the bottom inner surface opposes the top inner surface;
a vertical column interspersed between the top enclosure and the bottom enclosure forming an interior space therebetween, wherein the vertical column comprises a plurality of fasteners disposed on either end of the vertical column, wherein the plurality of fasteners is configured for detachably coupling the vertical column to each of the top enclosure and the bottom enclosure;
a cover interspersed between the top enclosure and the bottom enclosure, wherein the cover is configured for enclosing the interior space; wherein the cover is further configured for allowing light to enter from a surrounding of the apparatus into the interior space, wherein the cover is removably attached to a bottom periphery of the bottom inner surface using a friction clasp;
a nutrition container configured for containing a nutritional medium;
a tray configured for holding a plant, wherein the tray comprises a water inlet configured for receiving water and nutrition into the nutrition container, wherein the tray comprises a tray top surface and a tray bottom surface, wherein the tray bottom surface comprises fins configured for guiding a flow of mist, wherein the tray further comprises:
a tray for plant comprising at least one plant holder configured for holding a plant;
a tray for micro green comprising a plurality of mini holes configured for holding a micro green; and
a tray for mushroom comprising a holder configured for holding a mushroom, wherein each of the tray for plant, the tray for micro green, and the tray for mushroom comprise a mist outlet configured for allowing mist to pass from the bottom interior space to the interior space;
a plurality of sensors configured for generating a plurality of sensor data representing a plurality of variables associated with the interior space, wherein the plurality of sensors comprises:
a camera configured for capturing images of the plant, wherein the camera is attached to the top inner surface, wherein the field of view of the camera encompasses the interior space;
a dual function temperature and humidity sensor configured for receiving an indication of a temperature and a humidity associated with at least one of the interior space and the bottom interior space, wherein the dual function temperature and humidity sensor is comprised in the bottom enclosure; and
a capacitive water level sensor configured for receiving an indication of water level in the nutrition container, wherein the capacitive water sensor is comprised in the bottom enclosure;
a plurality of environmental actuators configured for controlling a plurality of environmental variables associated with the interior space, wherein the plurality of environmental actuators comprises:
at least one LED configured for emitting radiation for facilitating growth of the plant, wherein the at least one LED is comprised in the top enclosure;
an LED diffuser optically coupled to the at least one LED, wherein the LED diffuser is configured for evenly distributing the radiation emitted by the at least one LED, wherein the LED diffuser is comprised in the top enclosure;
a first piezo pump configured for generating mist to facilitate irrigation of the plant, wherein the first piezo pump is comprised in the bottom enclosure;
a second piezo pump configured for generating mist to facilitate control of the temperature and the humidity;
a heating pad configured for increasing the temperature, wherein the heating pad is comprised in the bottom enclosure;
a heat sink configured for absorbing and transferring heat, wherein the heat sink is comprised in the bottom enclosure;
a cooling fan configured for generating an air flow for the heat transferred by the heat sink, wherein the cooling fan is comprised in the bottom enclosure; and
a fan configured for generating an air flow for the mist generated by the first piezo pump, wherein the fan is mounted on the top inner surface, wherein the fan is comprised in the top enclosure; and
a processing device communicatively coupled to the plurality of sensors and the plurality of environmental actuators, wherein the processing device is configured for:
controlling the plurality of environmental actuators based on the plurality of sensor data; and
analyzing the plurality of sensor data using a machine learning model.
